(19) United States
(12) Patent Application Publication
(10) Pub. No.: US 2025/0238268 A1
(43) Pub. Date: Jul. 24, 2025

(54) Furcifer: A Context Adaptive Middleware for Real-world Object Detection Exploiting Local, Edge, and Split Computing in the Cloud Continuum

(71) Applicant: The Regents of the University of California, Oakland, CA (US)

(72) Inventors: Matteo Mendula, Bologna (IT); Marco Levorato, Irvine, CA (US); Paolo Bellavista, Cesena (IT); Sharon Ladron de Guevara Contreras, Ecatepec (MX)

(73) Assignee: The Regents of The University of California, Oakland, CA (US)

(21) Appl. No.: 19/033,878

(22) Filed: Jan. 22, 2025

Related U.S. Application Data
(60) Provisional application No. 63/624,770, filed on Jan. 24, 2024.

(51) Int. Cl. G06F 9/50; G06N 3/0455; G06N 3/0495

(52) U.S. Cl. CPC G06F 9/5027; G06N 3/0455; G06N 3/0495

(57) ABSTRACT

The technology disclosed provides Furcifer: a framework capable of dynamically adapting the cloud continuum computing configuration in response to the perceived state of the system. Our container-based approach incorporates low-complexity predictors that generalize well across operating environments. In addition, we develop a highly optimized split Deep Neural Network model, which achieves in-model supervised compression and enhances task offloading. Experimental results for object detection across diverse conditions, environments, and wireless technologies, show Furcifer's remarkable outcomes, including a 2× energy reduction, 30% higher mean Average Precision score than pure local computing, and a notable three-fold increase in frame per second rate compared to static offloading.

### PRIORITY APPLICATION

This application claims the benefit of U.S. Patent Application No. 63/624,770, entitled “FURCIFER: A CONTEXT ADAPTIVE MIDDLEWARE FOR REAL-WORLD OBJECT DETECTION EXPLOITING LOCAL, EDGE, AND SPLIT COMPUTING IN THE CLOUD CONTINUUM,” filed on Jan. 24, 2024 (Attorney Docket No. UCI1001USP01). The provisional patent application is incorporated by reference for all purposes.

### STATEMENT REGARDING FEDERALLY SPONSORED RESEARCH OR DEVELOPMENT

This invention was made with Government support under Grant No. 2134567, awarded by the National Science Foundation. The Government has certain rights in the invention.

### FIELD OF THE TECHNOLOGY DISCLOSED

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. In particular, the technology disclosed relates to Furcifer, a framework capable of dynamically adapting the cloud continuum computing configuration in response to the perceived state of the system.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

### DESCRIPTION OF RELATED ART

Modern real-time applications widely embed compute-intense neural algorithms at their core. Current solutions to support such algorithms either deploy highly optimized Deep Neural Networks at mobile devices or offload the execution of possibly larger higher-performance neural models to edge servers. While the former solution typically maps to higher energy consumption and lower performance, the latter necessitates the low-latency wireless transfer of high volumes of data. In highly dynamic environments with unreliable connectivity and rapid increases in concurrent clients, it is difficult to determine the appropriate computing configuration.

It is desirable to provide a system that can reliably determine the most appropriate computing configuration in a given network environment.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIGS. 1A, 1B and 1C presents an example representation of computation distribution between a mobile device (MD) and an edge server (ES) for local, split, and edge computing scenarios.

FIG. 2 presents an example illustration of a best performing computing modality and associated MD's power consumption as a function of signal strength and number of connected users.

FIG. 3 presents an example setup of the technology disclosed and architectural representation.

FIGS. 4A and 4B present examples of components of the technology disclosed on a mobile device (MD).

FIG. 4C presents graphical illustrations of overhead as a function of monitoring frequency.

FIG. 5A presents graphical illustrations for startup time breakdown and resource footprint comparison.

FIG. 5B presents an example illustration of footprint of GPU enabled containers for local computing (LC), split computing (SC) and, edge computing (EC) for object detection (OD) computing configurations.

FIG. 5C presents comparison of various split computing configuration models.

FIGS. 6A, 6B, 6C and 6D present graphical illustrations for IEEE 802.11n experiments using the technology disclosed.

FIG. 6E presents dataset collections settings for experiments, using the technology disclosed, in indoor and outdoor scenarios.

FIGS. 7A and 7B present example graphs for IEEE 802.11ac frames per second (FPS) rate metric using the technology disclosed.

FIG. 8 presents graphs illustrating comparison between the (a) 802.11n and 802.11ac and (b) 802.11n and Wi-Fi protocols, depicting the FPS fails score with an increasing number of concurrent clients.

FIGS. 9A and 9B present comparison between edge computing configuration and split computing configuration in their respective resource utilization and power consumption.

FIG. 10A present an example low complexity pareidolic algorithm.

FIG. 10B presents a table, which reports the resulting loss metrics for the evaluation of the regressors when training and applying them on specific environments (e.g., indoor, or outdoor).

FIG. 11 presents graphs illustrating choices distribution of considered computing configurations depending on target FPS rate for the (a) ground truth oracle and (b) Pareidolic Policy manager of the technology disclosed.

FIG. 12A presents a table, which reports the root mean squared error (RMSE) between the percentage of choices made by a PPM (pareidolic policy manager) low complexity policy manager of the technology disclosed and a baseline DRL agent.

FIG. 12B presents graphs illustrating mAP gain and energy saving with IEEE (a) 802.11n and (b) 802.11ac Wi-Fi protocols.

FIG. 13 shows graphical illustrations for best computing strategy ground truth versus predicted for each forecasting window size.

FIG. 14 presents performance metrics at different prediction window duration.

FIG. 15 presents a graph illustrating energy saving with FPS and Accuracy gains of PPM versus static local computing configuration.

FIG. 16 presents an example process flow diagram illustrating operations performed by the technology disclosed.

FIG. 17 shows an example computer system that can be used to implement the technology disclosed.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### INTRODUCTION

Computing applications widely embed compute-intense neural algorithms at their core. Current solutions to support such algorithms either deploy highly optimized Deep Neural Networks at mobile devices or offload the execution of possibly larger higher-performance neural models to edge servers. While the former solution typically maps to higher energy consumption and lower performance, the latter necessitates the low-latency wireless transfer of high volumes of data. Time-varying variables describing the state of these systems, such as connection quality and system load, determine the optimality of the different computing configurations in terms of energy consumption, task performance, and latency. Herein, we propose “Furcifer”, a framework capable of dynamically adapting the cloud continuum computing configuration in response to the perceived state of the system. Our container-based approach incorporates low-complexity predictors that generalize well across operating environments. In addition, the technology disclosed comprises a highly optimized split Deep Neural Network model, which achieves in-model supervised compression and enhances task offloading. The technology disclosed utilizes container-based services and low-complexity predictors that generalize across environments. The technology disclosed supports supervised compression as a viable alternative to pure local or remote processing in real-time environments. Experimental results for object detection across diverse conditions, environments, and wireless technologies, show Furcifer's remarkable outcomes, including a 2× (or two-fold) energy reduction, 30% higher mean Average Precision (mAP) score than pure local computing, and a notable three-fold increase in frame per second rate compared to static offloading. In highly dynamic environments with unreliable connectivity and rapid increases in concurrent clients, the predictive capabilities of the technology disclosed preserve up to 30% energy, achieving a 16% higher accuracy rate, and completing 80% more frame inferences compared to pure local computing and approaches without trend forecasting, respectively. The technology disclosed also achieves an additional 80% successful frame detections compared to traditional reactive computing strategy selection methods. In highly dynamic scenarios, where channel quality and the number of concurrent connected clients rapidly change, a simplistic reactive approach would excessively change computing strategies, potentially reducing the actual number of frames per second (FPS) for object detection tasks. To prevent this, the technology disclosed employs recent data to forecast future trends and then proactively react to system changes.

The increasing adoption of Machine Learning (ML) solutions in a broad range of real-world application scenarios has highlighted the need for system architectures with high flexibility and adaptability. However, the usability of ML algorithms in practical settings is often hampered by computing and communication limitations not considered during their development and evaluation stages. Challenges include constrained computing capabilities and energy budget of mobile devices, as well as communication channel capacity. Local Computing (LC) and Edge Computing (EC) stand as the primary pragmatic strategies for tackling the wide array of heterogeneous tasks in the broad range of real-world scenarios centered on the execution of complex data analysis and decision-making algorithms. On the one hand, LC, that is, the execution of the ML algorithm onboard a mobile device, aims at the optimal interplay between software applications and hardware components to efficiently harness available onboard resources. On the other hand, EC, where the ML tasks are offloaded to a compute-capable device positioned at the network edge, leverages high-performance communication and computing technologies to effectively support real-time applications. While EC promises higher computational capabilities and lower energy consumption to pervasive mobile systems, it requires a high-capacity wireless link that may be not consistently available due to the volatile nature of wireless channels, resulting in unreliable computing services. Conversely, LC is a more reliable computing mode with near-deterministic performance. However, the deployment of ML models on mobile devices comes at the price of reduced lifetime due to high energy consumption and diminished performance due to limited onboard resources.

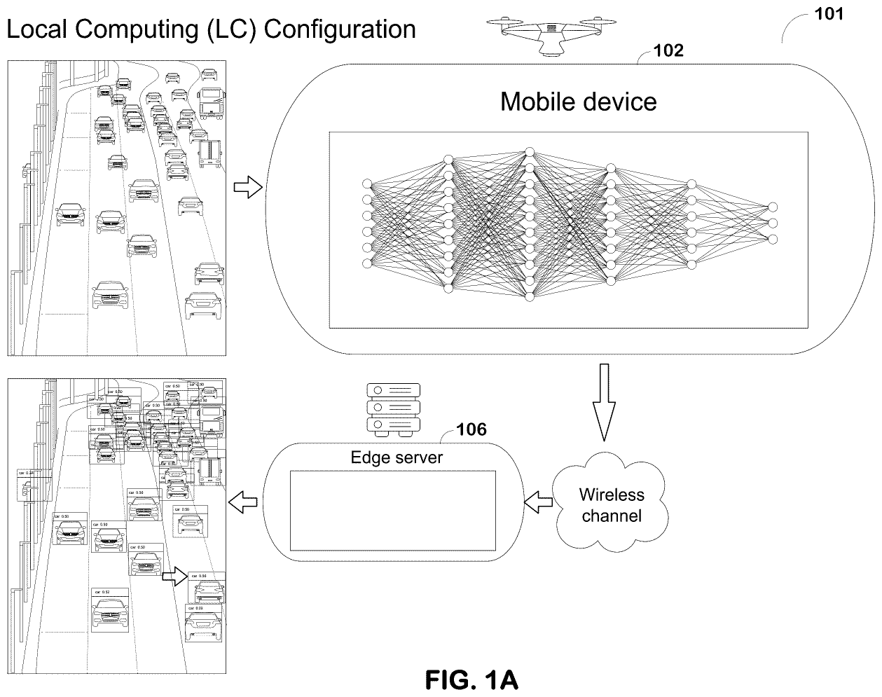

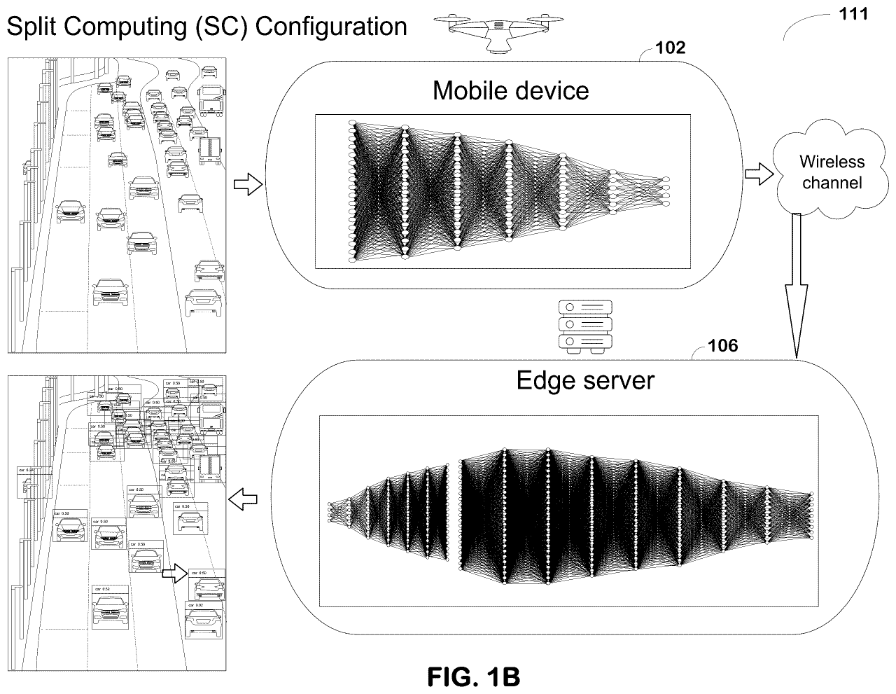

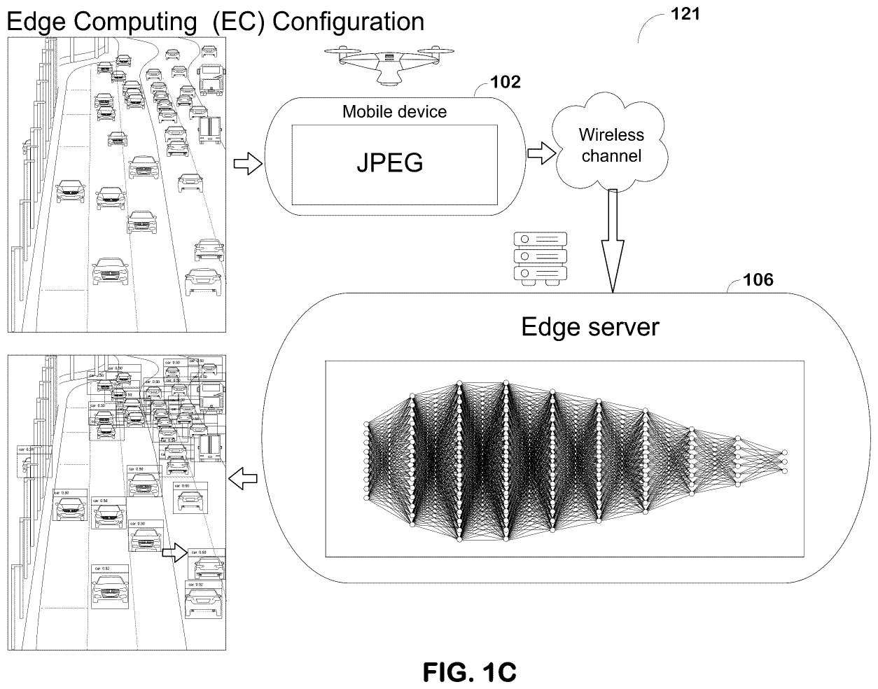

Recently, a third paradigm-Split Computing (SC), where sections of ML models optimized to facilitate offloading are allocated to the mobile device and edge server-emerged as a promising alternative to EC and LC (see FIGS. 1A, 1B and 1C). Indeed, the most advanced SC frameworks, where specialized models embed neural encoder/decoder-like structures, result in minimal computing load to the mobile device, while considerably reducing network usage.

Despite the substantial progress made in all the computing paradigms pursued by academic and industrial efforts, none of EC, LC, or SC can be deemed as universal cloud continuum solution providing the best performance in every scenario or system conditions even within specific application environments. The volatility and time-varying nature of a multitude of relevant parameters and state variables (e.g., channel quality, or network and server load) make online adaptation not just desirable to achieve optimal performance, but also necessary in practical deployments. However, adaptation of the computing configuration is largely unexplored if not in academic and theory-driven investigations, which often overlook critical characteristics and issues emerging in real-world systems and deployments. Moreover, despite its potential to become a critical computing configuration in many operational settings and system states, SC has yet to be evaluated beyond purely academic frameworks, making its ability to contend with EC and LC solutions unclear.

In response to these open technical challenges and deficiencies, the technology disclosed presents Furcifer, an innovative middleware framework specifically designed to provide seamless adaptation of the computing modality in realistic application environments. The technology disclosed transparently monitors the state of the underlying resources employed at runtime, by evaluating the current feasibility of EC, LC, and SC configurations and operating an automated switching between them when appropriate. The technology disclosed implements a containerized approach that effectively support the dynamic transition between EC, LC and SC. Operatively, all three computing strategies are instantiated on startup time to be selected with no additional overhead according to quality of service (QOS) requirements. Experimental results demonstrated the capabilities of the middleware to reduce context switch latency between different computing modalities (or computing configuration) to less than 45±2 ms. This is achieved by using storage as an additional and inexpensive resource. The applicability of the technology disclosed is presented, as an example, to object detection (OD), a representative Computer Vision task performed collaboratively between edge devices and mobile systems. describes our extensive assessment work that has involved a measurement The details of the technology disclosed are presented below.

### Furcifer: System Design and Implementation

The technology disclosed is referred to herein as “Furcifer.” Furcifer comprises an innovative middleware framework specifically designed to provide seamless adaptation of the computing modality in realistic application environments. The technology disclosed transparently monitors the state of the underlying system, predicts at runtime the feasibility of edge computing (EC), local computing (LC), and split computing (SC) configurations in highly dynamic environments, and switch between them. The technology disclosed comprises a containerized approach that can effectively support dynamic and low-overhead transition between the above-mentioned computing configurations (i.e., EC, LC, and SC) as well as between data compression and preprocessing modules. The technology disclosed reduces context switch latency between different computing configurations by using storage as an additional and inexpensive resource. For example, in one implementation, the technology disclosed can perform the context switching in less than 2 ms. Upon instantiation, the utilization of multiple lightweight containers results in an occupancy of approximately 7 GB on storage. Remarkably, at runtime less than 0.3% of this storage occupancy is transmitted over the network on demand depending on the specific task at hand. The technology disclosed comprises a system monitoring feature implemented in an extremely efficient manner and that introduces minimal overhead. The technology disclosed embeds algorithms that analyze the system state and predict the best computing configuration. Results demonstrate how these models can be made extremely lightweight and simple, a critical need to make real-world deployment practical even in severely resource-constrained mobile devices.

A comprehensive assessment of the technology disclosed is provided, emphasizing its application in object detection (OD). However, it is important to note that the technology disclosed is designed to facilitate the deployment of various distributed components within the cloud continuum, specifically tailored for pervasive mobile scenarios. The technology disclosed is evaluated using an extensive measurement campaign encompassing more than 250 indoor and outdoor experiments, featuring wireless technologies, such as the IEEE 802.11n and 802.11ac Wi-Fi protocols. This exhaustive investigation underscores the need to dynamically adapt the computing configuration to consistently meet application demands. In our tests, the technology disclosed achieved an impressive 2× (two-fold) reduction in energy consumption and an additional 30% mean Average Precision score compared to LC, while also delivering a remarkable three-fold frame per second rate increase compared to EC. Moreover, we demonstrate the highly optimized SC module embedded in Furcifer that outperforms both state-of-the-art practical EC and SC computing configurations in some parameter regions, thus establishing SC as a critical element in the array of available computing configurations.

The technology disclosed provides dynamic, seamless, and almost no-overhead adaptation logic e, which adjusts to the current state of each mobile and edge node. The technology disclosed comprises:

1. An innovative middleware technology that enables real-time monitoring of cloud continuum resources, encompassing energy budget, connectivity capabilities, computational resources, and target application performance.

2. A low-overhead container-based model adaptation which allows the switch to a different model with minimal latency and negligible additional bandwidth usage.

3. The first split computing (SC) encoder-decoder model competitive against highly optimized state-of-the-art object detection (OD) models used in practical applications.

4. A dataset consisting of more than 250 indoor and outdoor experiments, encompassing diverse scenarios with mobile devices operating under a broad range of channel conditions, wireless technologies, and system load levels.

5. A thorough evaluation of communication and execution times, including seldom investigated, but critically important, pipeline components such as camera acquisition, image parameters and data preprocessing.

6. A low complexity policy management module, trained on the dataset and experiments above, capable of optimizing the computing configurations, based on target power consumption, OD performance, and overall latency.

7. An innovative middleware for distributed object detection tasks capable of switching between EC, SC and LC.

8. A time series prediction component capable of attenuating context adaptation frequency, thereby reducing unsustainable context switch costs.

### Description of the Principles Used by the Technology Disclosed

The technology disclosed uses the following principles: (a) Edge computing context adaptation, (b) Image compression and (c) Energy consumption on embedded systems.

### A. Real-World Context Adaptation in Edge Computing

Dynamic offloading of computational load to edge servers is essential to support resource-intensive applications on constrained mobile devices while meeting demanding quality of service (QOS) requirements. Despite substantial advancements in self-adaptive offloading strategies, most state-of-the-art solutions have mainly tackled this optimization problem from a theoretical perspective. Recent studies have investigated the benefits of context aware adaptation for specific tasks such as 4k mobile augmented reality (AR) and mobile video streaming providing an in-depth overview of the set of optimization operations required to effectively deploy self-adaptive policy managers in real-world field experiments. Progressive adaptation to different object detection (OD) contexts using synthetic data or uncertainty-aware domain adaptation networks proved to be a promising direction when implementing a machine learning-based (or ML-based) solution in real-world scenarios. Furthermore, employing strategies such as the random exploration of optimal scaling factors can help alleviate the negative effects of source domain bias. However, these approaches often fail to consider critical system metrics such as energy consumption and network occupancy. In stark contrast with the current state of the art, the technology disclosed (also referred to as Furcifer) takes a comprehensive approach by tackling both system related and computer vision challenges, demonstrating the practical deployability of low-complexity policy managers in constrained scenarios. The technology disclosed comprises state logic configured to determine a current state of the mobile device based on one or more detected system metrics of the mobile device. In one implementation, the system metrics of the mobile device are detected from operating system registries of the mobile device. The detected system metrics of the mobile device can include at least one of energy consumption metrics and resource utilization metrics. The detected system metrics of the mobile device can also include at least one of network quality, packet transmission and drop rates, central processing unit (CPU) usage for individual cores, storage utilization, graphic processing unit (GPU) usage percentage, and temperature measurements.

### B. Image Compression and Object Detection

Many neural models for computer vision, and object detection (OD) in particular, are commonly trained and evaluated using state-of-the-art datasets such as COCO2017 and Pascal VOC. However, these evaluations often overlook the significant performance degradation caused by image compression, which is inevitable in practical edge computing (EC) systems. Notably, widespread image compression techniques are designed for human perception rather than for image analysis. The technology disclosed comprises image compression and storage logic configured to store well-tailored images optimized for each compatible mobile device in specialized container registry of each mobile device. The well-tailored images can be cached for future use based on a specific task the mobile device is assigned. As a consequence, high performance requires the transfer of large volumes of data over capacity-constrained channels. To address this issue, split computing or SC (also known as supervised compression in some contexts) has recently emerged as a promising alternative to achieve state-of-the-art performance in computer vision tasks while effectively reducing bandwidth usage. The idea is to incorporate encoder/decoder-like structures within the machine learning models themselves and use specialized training techniques to train task-oriented compressed representations. Knowledge distillation is one of the tools used to maximize the effectiveness of SC frameworks.

Existing techniques do not provide an evaluation of split computing (SC) for a complete computer vision pipeline. The technology disclosed addresses this gap by-providing components implementing logic for preprocessing, acquisition, and determination of timing characteristics that significantly influence the overall performance of a computing configuration. Additionally, the technology disclosed highlights the importance of proper model optimization, noting that SC is frequently compared to non-quantized models rarely used in practical deployments. The technology disclosed provides an evaluation of the resilience of SC frameworks to quantization and to evaluate their performance compared to optimally designed models for embedded computers.

### C. Energy Consumption on Embedded Systems

While much of the current machine learning-related research is primarily focused on achieving the best task performance in the absence of resource restrictions, it is imperative to acknowledge energy consumption as a pivotal metric when considering mobile deployments. In recent years, initiatives such as “The Low Power Image Recognition Challenge” (LPIRC) and a burgeoning energy-conscious perspective have emerged, underscoring a deliberate shift towards evaluating energy consumption. This evolving approach aligns with a sustainable trajectory aimed at achieving “Green AI” standing in stark contrast to the opposite trend of “Red AI”.

In the domain of real-time computer vision, energy consumption is not solely determined by the number of “Floating Point Operations” (FLOPs) or “Multiply-Accumulate” (MAC) operations indicative of the model's complexity. Indeed, energy consumption is also proportional to the number of frames per second (FPS) processed by the system. Furthermore, an increase in image resolution results in a significantly expanded tensor space representation within the hardware accelerator. This expansion necessitates the activation of a larger portion of the hardware board to harness the advantages of parallelized convolutional operations. Although in-depth studies address energy optimization from an embedded system perspective, current state of the art falls short of evaluating this aspect from a holistic cloud continuum perspective. The technology disclosed aims to strike a balance between resource efficiency and predictive precision, spanning from the edge to the cloud, and catering to the comprehensive energy optimization needs of modern mobile computing. By minimizing the energy consumption of mobile devices based on the desired mean Average Precision (mAP) score FPS rate, the technology disclosed represents a leap forward in realizing practical ubiquitous computer vision applications.

### Problem Statement and Preliminaries

An overview of the technological problem addressed by the technology disclosed is presented in this section. The environment comprises a cluster of mobile devices (MDs) 102 and an edge server 106 (ES) collaboratively perform object detection (OD) on the streams of images generated by the MDs 102. Three computing strategies (also referred to as computing configurations and computing modalities) to achieve an optimal operating point in terms of energy consumption, OD performance, and frame rate are presented below. The three computing strategies are illustrated in FIGS. 1A, 1B and 1C.

Edge Computing: The edge computing (EC) strategy or the edge computing configuration is labeled as 121 in FIG. 1C. The images captured by the mobile devices 102 are passed via wireless channel to edge server (ES) 106. The execution of the task on the edge server allows the use of high-performance models (e.g., large non-quantized models). However, the limited computing capabilities of ESs compared to cloud servers means that the server may not be able to serve a large number of task streams. Moreover, the need to transfer the input data (e.g., images) to the ES means that robust and high-capacity wireless channels are needed. While image and video compression techniques significantly lower data transmission costs, they also diminish the model's ability to extract meaningful information from processed images once a certain compression threshold is exceeded.

Local Computing: The local computing (LC) strategy or the local computing configuration is labeled as 101 in FIG. 1A. In settings where the task complexity is sufficiently low to match the capabilities of the mobile device, then local execution of the algorithm is a viable option. A trade-off is struck between task performance, power consumption and frame rate. Importantly, LC performance is not dependent on the state of the wireless channel connecting the MD to the ES, or the network and server load. In this context, quantization assumes a pivotal role in reducing execution time and energy consumption and enabling the use of better performing models whose use would otherwise be impractical on resource-constrained devices with limited computational capabilities. In addition, while being completely resilient to signal strength fluctuation, LC implies high energy usage, consequently leading to a reduced battery lifespan.

Split (collaborative) Computing: The split computing (SC) strategy or the split computing configuration is labeled as 111 in FIG. 1B. In SC configuration, a subset of operations that would be executed on the ES is allocated to the mobile device instead. This subset often includes pre-processing operations, such as JPEG encoding, and partial model inference altered to embed neural supervised encoding. The objective is to decrease the amount of data to be transported over the wireless channel while minimizing the MD's involvement, and possibly also decreasing server load. This computing configuration proves advantageous in settings where the communication channel's reliability is compromised, bandwidth demands exceed channel capacity or computing demands exceed server capacity. SC configuration is specifically designed to address this scenario by mitigating both channel usage and computation burden on the ES. Existing SC solutions are not competitive with LC and EC, as the inference time on the mobile device often exceeds real-time requirements, or the size of the output from the first portion of the model exceeds that of the image itself, making SC less convenient compared to LC (faster) and EC (more bandwidth-efficient). In contrast, our proposed SC encoder achieves an inference time comparable to LC while delivering a superior compression ratio compared to EC, positioning SC as a practical and efficient intermediary between the two approaches.

Computing strategies comparison: The most popular metric used to evaluate object detection (OD) is mean Average Precision (mAP), which combines precision and recall values based on Intersection over Union (IoU) scores across various levels of confidence thresholds. Typically, mAP scores are obtained by testing the algorithm on benchmark datasets such as COCO2017. However, when deploying an OD engine in a real-world setting, various factors such as camera resolution or scaling factor alterations come into play to determine the performance perceived by the application. Additional factors such as model quantization and image compression also play a significant role. With these in mind, we conduct an extensive evaluation of EC or edge computing configuration and LC or local computing configuration, as well as Furcifer's SC (or split computing configuration) engine. A Jetson Nano Dev Kit device is used as a mobile device, connected to a Jetson AGX Orin Dev Kit that acts as edge server (or ES). At the ES, a modified version of Faster R-CNN is deployed with Res50 backbone as a feature extractor testing various JPEG compression rates: 0%, 50%, and 70%. We also explore high frame rate alternatives for LC. Specifically, we select a quantized FP16 version of YOLOv5 and SSD300, a customized adaptation of the Single Shot MultiBox Detector (SSD) developed by NVIDIA™.

A specialized encoder-decoder architecture is developed that is trained using supervised compression and Faster R-CNN as a teacher model. Teacher-student training is a technique for speeding up training and improving convergence of a neural network using a pre-trained teacher network or teacher model. The resolution adjustment is implemented to facilitate quicker inference on resource-constrained devices. By adopting these modifications, the technology disclosed enhances the efficiency of the SC or the split computing configuration while maintaining satisfactory detection performance. The design is optimized by quantizing the encoder to FP16 (16-bit floating point number) and by running it with an optimized inference engine. Quantization is the process of mapping machine learning model weights to a different number format that uses fewer bytes per parameter. This makes the model inference faster by making memory access more efficient. It is understood that other precisions for model weights can be used such as FP32, FP8, etc. In addition, the student model is finetuned in order to match the camera resolution with the feature extractor upscaling factor. Further details about the distillation process are provided in one of the following sections. The technology disclosed further enhances this model by quantizing the encoder to FP16 and crafting an optimized inference engine for improved efficiency. Furthermore, the student model is fine-tuned to align the camera resolution with the feature extractor's upscaling factor then reducing the size of the input tensor fed to the feature extraction portion of the encoder. Additional details regarding the custom distillation process are discussed in the one of the following sections.

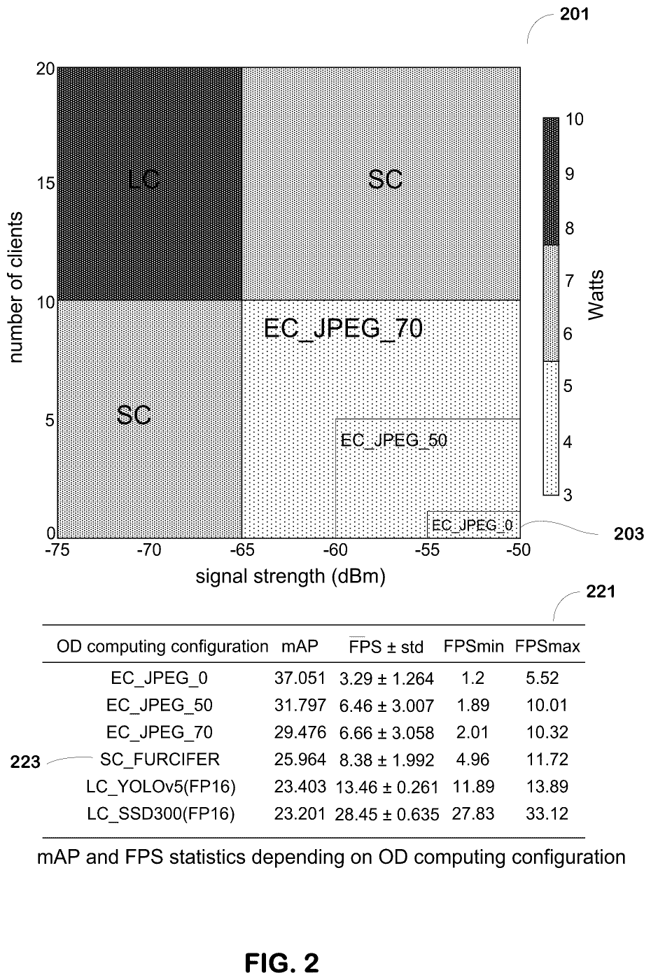

FIG. 2 presents an example illustration of a best performing computing modality and associated MD's power consumption as a function of signal strength and number of connected users. A graphical illustration in FIG. 2 presents performance results for the technology disclosed in comparison with other object detection (OD) techniques listed in a table 221. A table 221 in FIG. 2 provides a comparison of the frame per second (FPS) and mAP obtained by each computing configuration (or computing modality) and model, whereas a graphical illustration 201 in FIG. 2 shows the computing modality achieving the best FPS rate and the associated power consumption (mobile device or MD only) as a function of signal strength (MD to ES channel) and the number of connected users. The results show that the best mAP performance is obtained using EC (edge computing configuration) without JPEG compression—that is, the largest model with uncompressed image. This is labeled as 203 in bottom right corner of the graphical illustration 201. Conversely, the maximum frame rate is achieved by a quantized model deployed at the MD. From the fourfold comparison of power consumption, FPS rate, mAP, and bandwidth usage, (i) EC stands out as the most favorable strategy under optimal signal conditions. It preserves MD battery life while achieving higher-quality object detections. (ii) SC is the preferred choice when the MD remains connected, but the wireless channel cannot support even compressed image transmission. This approach reduces the computational load on the edge server and achieves a higher mAP compared to LC. Conversely, (iii) LC is the least desirable option, as it significantly reduces MD battery life and delivers the lowest object detection quality.

The graphical illustration in FIG. 2 shows that the best configuration is a function of system load and channel state, and how different options result in a different amount of power spent by the MD. As presented later, Furcifer outperforms edge computing configuration (EC) in terms of speed by achieving up to twice the FPS rate, all while attaining a higher mAP score in low channel quality scenario compared to the LC models (223). The graphical illustration (in FIG. 2) shows that power consumption LC (top left) is by far the most demanding computing strategy. When the whole computation is performed on the mobile device, this results in a peak of 10 Watts, drastically reducing the lifetime of MD. However, the complete autonomy of LC from the edge server makes it the only viable option when poor signal strength prevents any communication with the edge server or when the total number of concurrent clients does not allow the server to process incoming messages while guaranteeing quality of service (QOS) requirements. On the opposite end of the spectrum (bottom right), EC emerges as the most efficient strategy for preserving MD battery life. This is because only minimal, computationally negligible pre-processing operations are performed on the mobile device. However, this approach comes with drawbacks: the number of clients that can be simultaneously supported is limited, and it requires strong signal strength to transmit the captured images to the edge server effectively. As an intermediary solution, SC splits the computation between MDs and the edge server while reducing the amount of data transferred over the network. Given a smaller bandwidth usage compared with EC, SC emerges a viable option in those cases when: (i) the MD remains reachable, but the limited signal quality prevents the transmission of compressed images, or (ii) the edge server is operating at full capacity, and additional concurrent clients require further tasks to be processed.

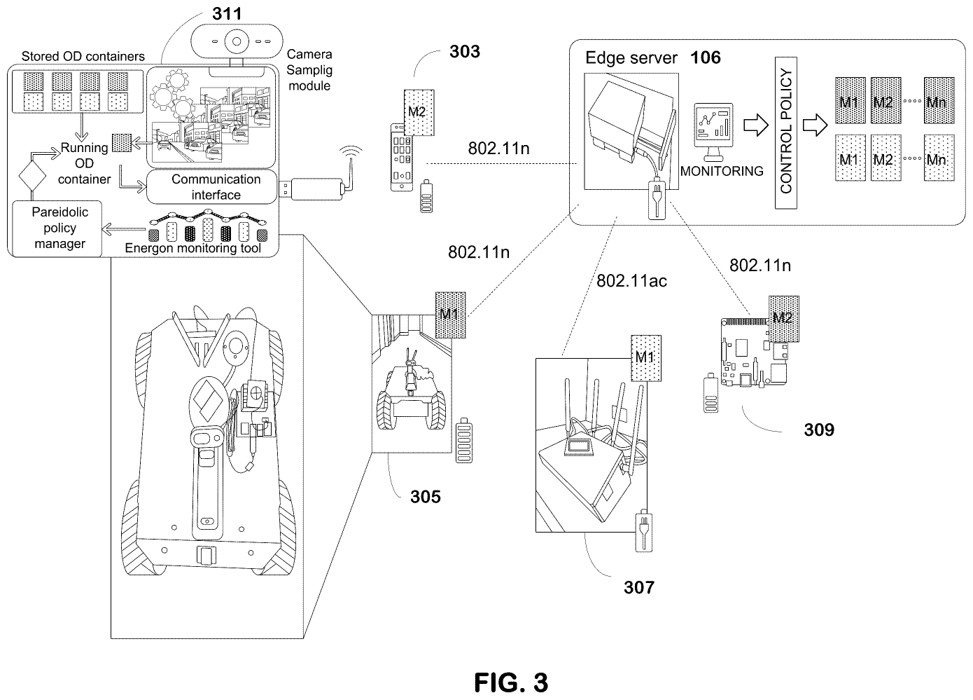

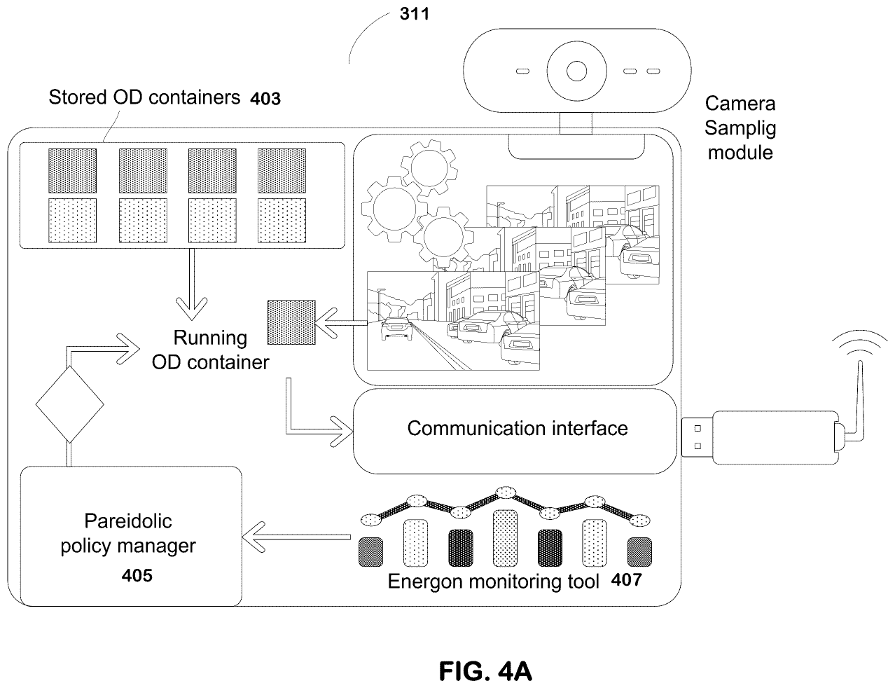

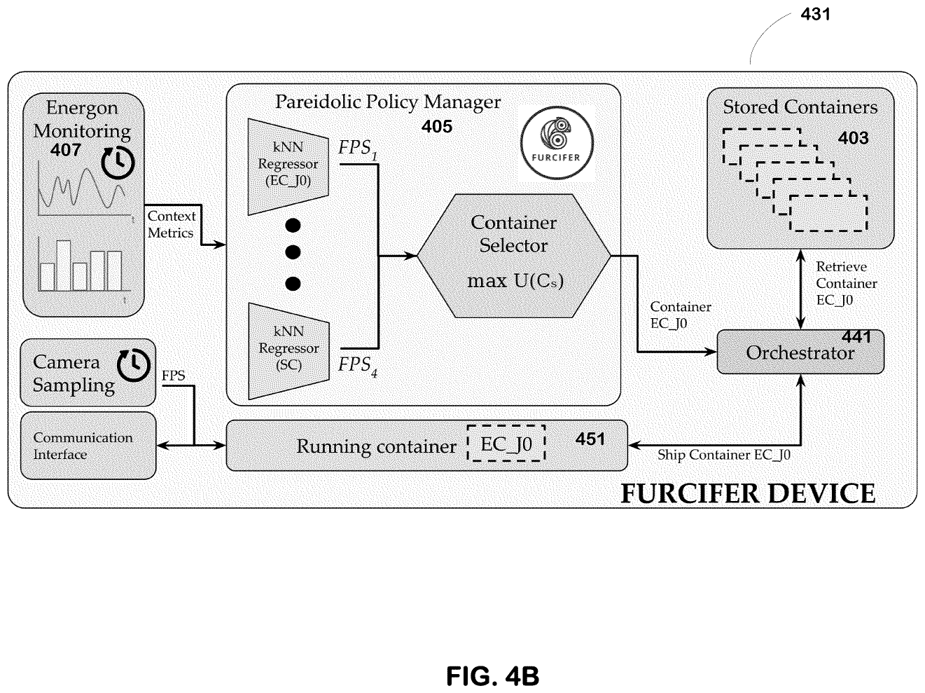

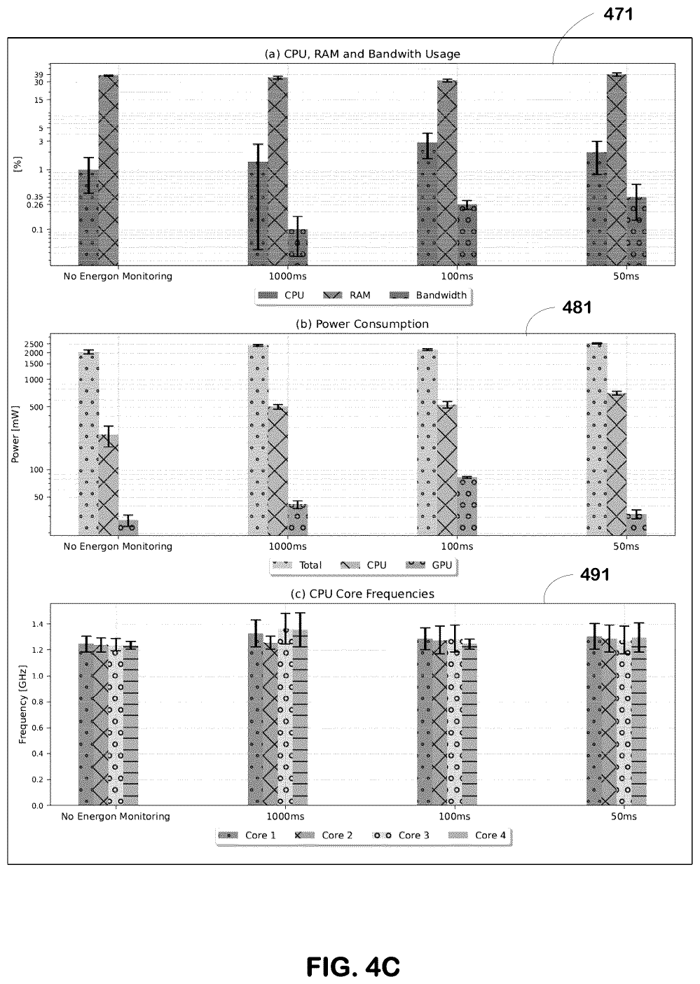

The quantitative indicators presented in the previous section emphasize that there is no absolute winner among EC, SC, and LC computing configurations even when considering a specific task, computing platforms, and communication technology. Instead, the—time varying—state of the system, which is influenced by mobility and load dynamics, determines the best computing configuration (or computing strategy). This variability arises because the most efficient strategy, EC, heavily relies on the quality of wireless connectivity, which in turn depends on the mobility of the MD over the time. Furthermore, stochastic surges in concurrent client connections could compromise the feasibility of this approach, making SC a more suitable alternative when some connectivity is still available. In the worst-case scenario, where the MD is no longer reachable, the system defaults to LC as the only viable option. However, changing the computing modality in real-world deployments is technically nontrivial. The technology disclosed (also referred to as Furcifer) comprises an adaptation engine composed of highly effective containerized models whose activation is determined by a control module informed by comprehensive system monitoring. While every element within the system holds a crucial role to enable adaptation to context, the container-based Service-Oriented Architecture (SOA) nature of Furcifer enables the independent deployment of each component. The technology disclosed tackles this obstacle by encapsulating each computing strategy within a container (containerized task execution engines). The technology disclosed addresses the dynamic adaptation of computing strategies by encapsulating each computing strategy (of computing configuration) within a container. This containerization approach packages the code along with its dependencies, ensuring that the ML application operates efficiently and reliably across varied computing environments. It also enables seamless transitions between machine learning (ML) models based on the specific characteristics of the context. The resulting highly efficient containerized models are then dynamically activated based on two key factors: (i) the current signal quality and (ii) the number of concurrent users connected to the edge server. Further details about the policy manager are provided in one of the following sections. The technology disclosed provides a set of task execution engines such that each containerized task execution engine in the set of containerized task execution engines is configured to be executed using a computing configuration selected from a plurality of different computing configurations. Examples of computing configurations include edge computing (EC), local computing (LC) and split computing (SC). The technology disclosed comprises a runtime logic that is configured to execute the at least one containerized task execution engine using the currently selected computing configuration. The runtime logic operates in communication with control logic that generates a current control signal based on the current state of the mobile device. In one implementation, the task execution engines in the set of containerized task execution engines are objection detection engines. The containerization bundles the code and its dependencies, ensuring the application (such as the object detection or OD application or any other desired application) operates swiftly and reliably across diverse computing environments and facilitating a seamless transition between running OD models based on specific context characteristics. In one implementation, the objection detection engines comprise a specialized encoder-decoder neural network architecture having a one-channel bottleneck in initial layers of a feature extraction segment of the specialized encoder-decoder neural network architecture. The specialized encoder-decoder neural network can incorporate quantization (e.g., INT8 or other types of quantization techniques) at an end of the specialized encoder-decoder neural network architecture. Within this section, we provide an in-depth discussion of the main features of each component while graphically representing the overall architecture and component unit in FIGS. 3 and 4. FIG. 3 provides an example setup and architectural representation of the technology disclosed. FIG. 4A presents various components of the technology disclosed on a mobile device in one implementation of the technology disclosed. FIG. 3 shows four mobile devices 303, 305, 307 and 309 connected to an edge server 106 via respective wireless communication protocols. The illustration 311 in FIG. 3 presents example components of the technology disclosed on a mobile device. FIG. 4A presents a zoomed-in view of illustration 311. The illustration 311 shows object detection containers 403 that are stored on the mobile device. A Parcidolic Policy Manager (or PPM) 405 and an Energon monitoring tool (407) are also implemented as part of the components deployed on the mobile devices. Further details of these components and their interconnections are presented in the following sections. FIG. 4B presents another example architecture 431 of the components of the technology disclosed as deployed on a mobile device. In the example architecture 431, the Energon monitoring component 407 communicates with he Parcidolic Policy Manager 405 by sending context metrics. The PPM sends the information regarding the container comprising the selected computing configuration to an orchestrator component 441. The orchestrator 441 then retrieves the selected container 451 for executing the computing configuration.

### A. Energon: a Transparent Energy Monitoring Module (State Logic)

The system monitoring component (also referred to as system monitoring module) implements state logic. This is a critical component as it informs Furcifer's decision making process. The state logic is configured to determine current state of the mobile device based on one or more detected system metrics of a mobile device (MD). The monitoring module integrates Energon component and Prometeus component. Energon component 407 collects system metrics from connected MDs by unobtrusively extracting data from the registries of the targeted operating system with minimal overhead to the monitored device and without the need to implement modifications to the application's underlying logic.

Energon component 407 focuses primarily on energy consumption and resource utilization in MDs, while also providing insights into additional metrics, including network quality, packet transmission and drop rates, CPU usage for individual cores, storage utilization, GPU usage percentage, and temperature measurements from various regions of the board. Scraped metrics are made available through an HTTP endpoint that can be queried on demand by the orchestrator.

To evaluate the technology disclosed, a series of experiments were conducted to quantify the overhead introduced by Energon component (also referred to as Energon) 407 on mobile devices. Over a 120-second interval, we collected system metrics under four scenarios: (i) without Energon, (ii) with Energon at a monitoring frequency of 1000 ms, (iii) at 100 ms, and (iv) at 50 ms. For baseline system metrics without Energon, we utilized Tegrastats, a robust and widely adopted tool provided by NVIDIA™ for monitoring Jetpack 2 based devices. The monitoring frequencies for Energon were restricted to 1000 ms, 100 ms, 50 ms, as 50 ms represents the experimental maximum frequency supported by the Prometheus standard on the Jetson Nano (Jetson Nano Dev Kit device is used as MD).

FIG. 4C illustrates Energon's overhead across various system components as a function of monitoring frequency. The results are presented in three parts. A first graphical illustration 471 presents a percentage utilization of CPU, RAM and bandwidth. A second graphical illustration 481 presents a comparison of total power consumption between CPU and GPU. A third graphical illustration 491 presents the individual core frequency dynamics. Specifically, the graphical illustration 471 reveals that higher monitoring frequencies have a negligible impact on CPU and RAM usage. Bandwidth usage, as expected, increases slightly with higher frequencies but remains below 0.35%. It is important to note that the values on the y-axis are scaled logarithmically to better highlight smaller variations.

In terms of power consumption, the graphical illustration 481 (in FIG. 4C) demonstrates that Energon does not introduce significant overhead in total, CPU, or GPU power metrics. Similarly, the graphical illustration 491 (in FIG. 4C) highlights that the core frequencies of the mobile device remain comparable across all scenarios, with or without Energon, regardless of monitoring frequency. Based on our assessment, we determined that a monitoring frequency of 50 ms is optimal for our system, as Energon introduces negligible overhead across all tested frequencies. The collected metrics are subsequently made available via an HTTP endpoint, which can be queried on demand by the policy manager at desired rate.

### B. From the Cloud to the Edge: On-Demand Image Pulling

The technology disclosed integrates GPU-enabled capabilities offered by the original Docker runtime in a lightweight version of the renowned container framework where unused modules were removed. The technology disclosed (also referred to as Furcifer) provides a specialized container registry specifically designed for image compression and storage. This registry stores well-tailored images optimized for each compatible device, which are cached for future use based on the specific task the device is assigned. For each device type, a subset of images shares identical interfaces with the operating system hypervisor. However, these images differ at the application layer and user library level, adapting to the specific task to be executed and the corresponding dependencies that are necessary. We choose to apply containerization as a practical way to guarantee flexibility and fast reactiveness of the framework to future environment states. This shift of paradigm from the cloud to the edge empowers proactive mechanisms that enable seamless adjustments in response to evolving context requirements. Our evaluation of the size of resulting container images reveals that less than 1% of the image comprises application-level files. This efficient design enables the download of only the last layer of the image, which has the same footprint size of the model itself. This approach minimizes network usage, since the model would anyway need to be transferred no matter whether a containerized approach is used or not. This approach ensures minimal network usage, as only the final layer of the container varies from the previous one, while the operating system platform and essential libraries remain consistent. Notably, it is quite reasonable to expect that the operating system and the majority of user libraries will remain unchanged when deploying a new model to address an incoming task. By adopting this approach, the well-established concepts utilized in cloud environments streamline the management and real-time adaptation of mobile and resource-constrained devices. This shift of paradigm from the cloud to the edge empowers proactive mechanisms that enable seamless adjustments in response to evolving context requirements. Our evaluation of the size of resulting container images reveals that less than 1% of the image comprises application-level files. This efficient design enables the download of only the last layer of the image, which is equivalent in size to the model itself. This approach minimizes network usage since the model would anyway need to be transferred no matter whether a containerized approach is used or not.

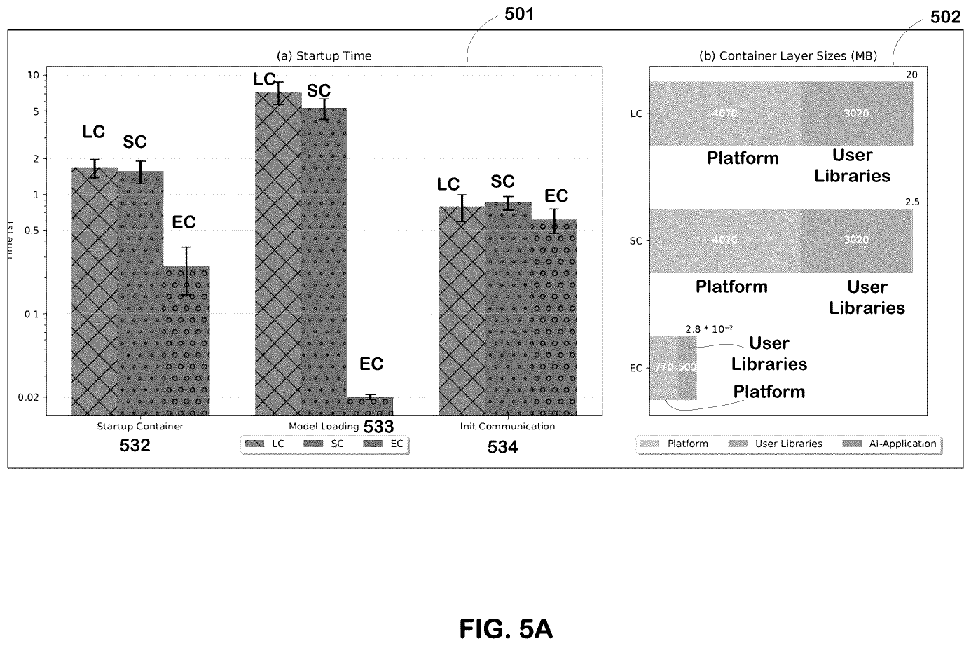

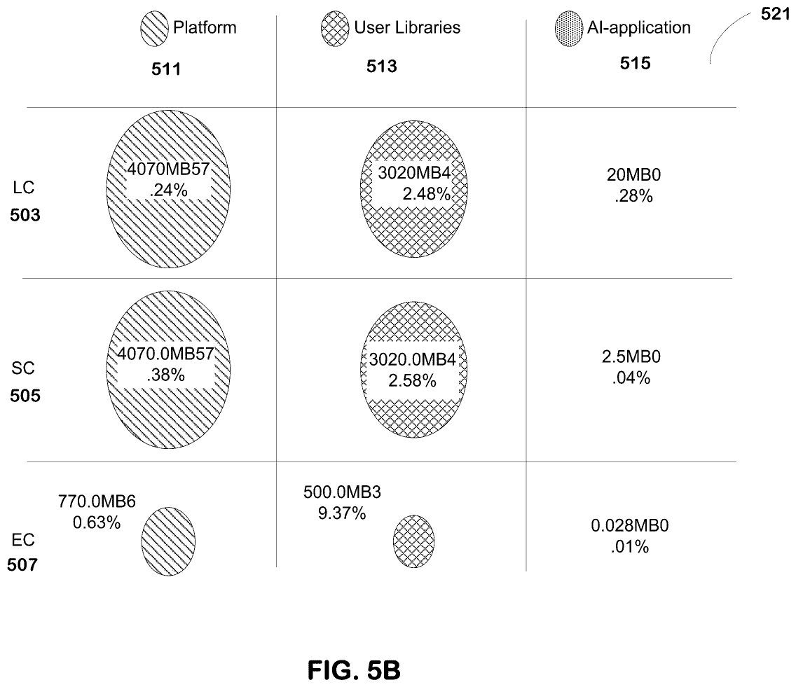

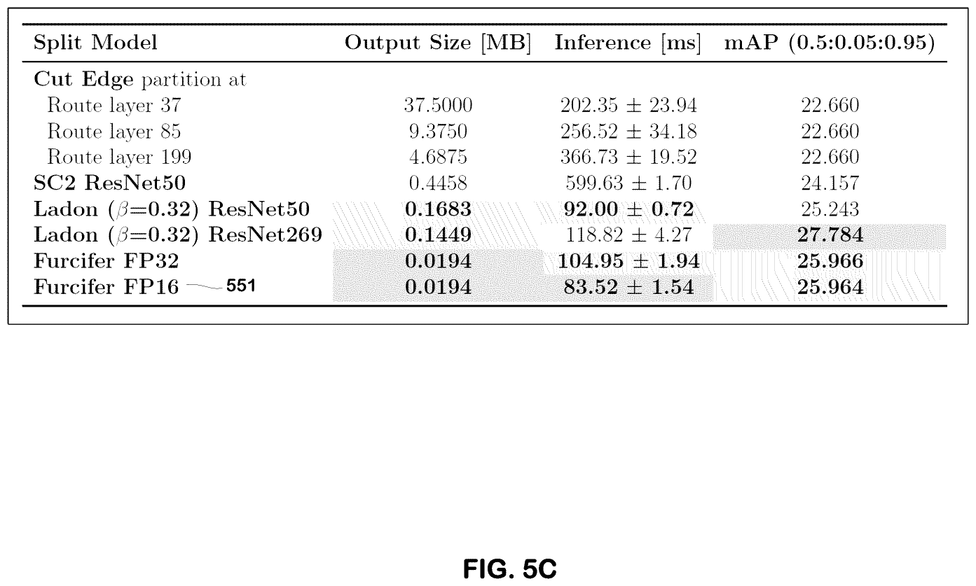

In FIG. 5A, a graph 501 illustrates the startup time for all available computing strategies across three key stages: Startup Container (labeled as 532), Model Loading (labeled as 533), and Init Communication (labeled as 534). The results show that the time required to initialize the container is highest for LC, followed by SC, with EC demonstrating the lowest and most efficient startup time. Model loading is the longest stage for all strategies, with LC and SC taking considerably more time compared to EC, which achieves the fastest loading time. For Init Communication, all computing configurations exhibit similar times. A graph 502 in FIG. 5A shows the memory footprint of Furcifer container images in the LC, SC and EC configurations. Notably, the memory requirements for hardware acceleration dependencies at both the platform and user library levels are about four times more extensive for LC and SC compared to EC. The contribution of the application layer remains minimal compared to the other components, reinforcing the viability of switching between containers on demand. This is achieved by pulling only the necessary components, specifically the last layer of the container image, thereby reducing unnecessary network usage and resource consumption. While startup times are notable, this delay does not pose a significant issue during operation. In fact, all three containers are launched simultaneously during device startup, thanks to optimizations that ensure all modes fit within the mobile device without the need for unmounting at runtime. As a result, switching between computing strategies incurs virtually no overhead, with a minimal delay of just 45±2 ms, which is solely attributed to the unavoidable GPU warm-up. The results in graph 502 (in FIG. 5A) are presented in FIG. 5B in another graphical illustration 521 to further illustrate the comparison of memory usage by platform, user libraries and user applications (such as AI applications).

FIG. 5B shows the memory footprint of Furcifer container images in the LC, SC, and EC configurations in a graphic illustration 521. The computing configurations (LC, SC and EC) are listed in rows 503, 502 and 507 respectively. The memory requirements for the three computing configurations are listed along three columns 511, 513 and 515. The memory requirements are illustrated separately for platform (511), user libraries (513) and artificial intelligence (AI) applications (515). The memory requirements for hardware acceleration dependencies at both the platform and user library levels are about four times more extensive for LC and SC compared to EC. The contribution of the application layer remains minimal compared to the other components, reinforcing the viability of switching between containers on demand. This is achieved by pulling only the necessary components, specifically the last layer of the container image, thereby reducing unnecessary network usage and resource consumption.

### C. Communication Interface and Protocol

Deployed containerized models correspond to a distinct and uniquely identified endpoint on the MD. Those microservices interact with the central orchestrator through a REST API, facilitating seamless communication and interaction while capitalizing on the advantages of minimal communication overhead. It continuously monitors for potential new connections and, in the event of a connection loss, takes informed countermeasures to address the situation by switching to a local computing strategy. Furcifer's REST APIs operate on a request-response TCP-based model, enabling the framework to discern round-trip packet latencies. This functionality allows the introduction of well-defined rules for filtering out requests characterized by excessive communication delays. This mechanism ensures that the framework remains responsive and efficient, even in scenarios where the network conditions might fluctuate. Exchanged messages are defined as follows:

1. keep alive: This message is periodically sent using a polling mechanism to ascertain the presence of mobile devices within the same network.

2. start/stop OD: This message instructs the Mobile Device MD to initiate or terminate an Object Detection task. When initiating a task, the message also specifies the preferred computing strategy among LC, SC, and EC.

3. release camera: Since the camera is a shared resource among deployed models on the MD, this message prompts the MD to release the camera lock, enabling other models to access the camera.

4. set target frame rate: This command sets the desired FPS rate for camera sampling based on dynamic requirements defined at the application level. Recognizing the direct correlation between higher FPS rates and increased power consumption, Furcifer intelligently conserves energy and network resources when higher-frequency camera sampling is unnecessary. To make an example, this capability could decrease energy usage of surveillance cameras in the absence of detected movement or to Vehicle-to-Vehicle (V2V) cameras in low-traffic environments.

5. set compression rate: If an EC configuration is used, the MD can opt to compress captured images before transmitting them to the ES for final detection. This message specifies the desired compression rate, controlling the balance between reduced compression for improved mAP score. Collectively, these message exchanges facilitate dynamic communication and coordination between the orchestrator and the mobile devices (MDs), enabling effective real-time adaptation and context-aware decision-making within Furcifer.

### D. Furcifer's SC Engine

The technology disclosed (Furcifer) comprises a new SC engine tailored for resource-constrained devices, marking a significant advancement in this real-world domain. Leveraging Faster R-CNN as the teacher model, the technology disclosed uses a modified version of the knowledge distillation process adopted in SC2 Benchmark to design a compact encoder optimized for constrained devices. This encoder serves a dual purpose: minimizing channel occupancy and effectively distributing computation load between mobile devices and the edge server. Differently from the original model described in we optimized each tensor operation to exploit the parallel execution on the GPU. The technology disclosed replaces the traditional matrix operations with cuDNN tensor operations, leveraging GPU parallel execution to its fullest potential. Additionally, the technology disclosed includes logic to execute the model using a TensorRT engine, enabling high-performance inference optimization. For the fine-tuning process, we utilize the COCO2017 dataset to ensure comparability with other proposed solutions. As an additional adjustment to the original encoder proposed in, we adopted a different pre-processing technique. The original teacher model, Faster R-CNN, requires input images to be scaled to a minimum height of 800 pixels, which is significantly larger than the original 640 pixels×480 pixels resolution of the COCO2017 dataset. As a result, the enlarged images reach a resolution of 1066×800 pixels, which exceeds the onboard computational capabilities of the mobile device, preventing real-time object detection within constraints. In, the same enlargement at the preprocessing stage is preserved to maximize the mean Average Precision (mAP) score, despite the increased inference time. To prioritize real-time performance, we adopted a smaller image upscaling transformation, limiting the height to 400 pixels. It is understood that other image upscaling transformations can be used by the technology disclosed.

The optimized encoder uses quantization and channel compression to reduce execution time as much as possible. To enhance data compression, we strategically place a one-channel bottleneck in the initial layers of the feature extraction segment of the network. This choice leads to further data reduction, increasing the efficiency of the whole process. Additionally, we incorporate INT8 quantization at the end of the encoder. This quantization approach optimizes the representation of the data, contributing to both improved data compression and streamlined computation. The dynamic nature of the system is upheld by calculating the scaling factor and zero point on a per-image basis as they are processed. These values are then communicated to the decoder located at the ES, along with the resulting INT8 tensor from the encoder inference process.

The technology disclosed capitalizes on the online INT8 quantization of the latent space between the encoder and the decoder. The encoder is novelly quantized from FP32 to FP16. The negligible impact on the mAP score of Furcifer's SC engine on the COCO2017 dataset has to be attributed to the already strong approximation performed on the latent space to INT8. As a result, the transition from FP32 to FP16 yields a minimal difference, further highlighting the convenience of the quantization process. The incorporation of INT8 quantization and dequantization for the inference tensor on the MD minimizes the influence of weight quantization within the encoder engine, which transitions from FP32 to FP16. There is negligible impact on mAP score testing Furcifer's SC engine on the COCO2017 dataset, obtaining 25.966 and 25.964 as mAP scores for FP32 and FP16, respectively. Thus, the adoption of an FP16 quantized encoder on the mobile device delivers a nearly twofold increase in processing speed compared to its FP32 counterpart, while preserving about the same mAP score. This finding underscores the additional advantage of applying quantization to SC encoders, which, unlike their LC counterparts, are already quantizing the final encoding result to minimize channel occupancy. As a result, they are less susceptible to mAP score reduction due to quantization. This optimization makes SC a competitive option against optimized models for embedded devices, as demonstrated by the results presented herein.

We extend the comparison of the technology disclosed to CutEdge, a well-known solution for model partitioning, and Ladon, a recent advancement for multitask image encoding. It is important to note that in CutEdge, not only is the detection model different, but no distillation techniques are used to reduce the size of the latent space. Instead, the authors dynamically partitioned YOLOv4-tiny based on context metrics such as edge server workload and mobile computing capabilities. Unsurprisingly, all comparison metrics highlight Furcifer's SC encoder as the best option, as its accuracy and resulting FPS rate outperform CutEdge. Nonetheless, we selected CutEdge for benchmarking to emphasize the crucial role of knowledge distillation in making SC comparable to the performance of LC and EC. We also included Ladon in our benchmark, the multitask evolution of SC2. In this case, the same teacher model is used in the distillation process, and both ResNet50 and ResNet269 backbones are tested to ensure a fair evaluation.

In FIG. 5C, we present a comparative evaluation of various split models and architectures based on three key metrics: latent space size, inference time, and mean Average Precision (mAP) at thresholds 0.5:0.05:0.95. The table includes results for CutEdge partition models at different route layers (37, 85, and 199) alongside more advanced architectures such as SC2 ResNet50, Ladon ResNet50, Ladon ResNet269, and two versions of Furcifer (FP32 and FP16). As the input image, we selected the standard resolution of 640 pixels×480 pixels to ensure compatibility with the evaluation conducted on the COCO2017 dataset. This choice results in an original input image size of 3.69 MB once converted from image to tensor. As a comparison, its JPEG encoding with no compression would result in a file of 0.1 MB. The results reported in FIG. 5C highlight the trade-offs between output size and inference time while maintaining competitive mAP. Specifically, the Furcifer FP16 model achieves the fastest inference time of 83.52 ms with an output size of 0.0194 MB, the smallest among all evaluated models. Similarly, the Ladon ResNet50 and Ladon ResNet269 models also demonstrate competitive performance, with output sizes of 0.1683 MB and 0.1449 MB, and inference times of 92.00 ms and 118.82 ms, respectively. The Ladon ResNet269 achieves the highest mAP of 27.784, showcasing its superior accuracy. In contrast, CutEdge, as an example of model partitioning, exhibits significantly larger output sizes and slower inference times, ranging from 202.35 ms at Route layer 37 to 366.73 ms at Route layer 199, while maintaining a consistent mAP of 22.660. This underscores the inefficiency of earlier split points in balancing output size and computational performance. Overall, the Furcifer FP16 (labeled as 551) and Ladon ResNet269 models emerge as the best-performing options, offering an optimal balance between inference speed, model compression, and accuracy.

When comparing Furcifer FP16 with Ladon ResNet269, we prioritize Furcifer FP16 due to its shorter inference time, making it more suitable for real-time applications. As a consequence, in our exploration of LC, SC, and EC, we selected our custom FP16 encoder as the SC option. This choice achieves the highest data compression with only a minimal reduction in mAP.

### E. Camera Sampling Module

The Camera Sampling Module (CSM) performs the capture of frames from accessible cameras, integrating essential drivers to ensure optimal performance with adaptability to various camera models. Additionally, this module offers to the user the ability to set precise directives for the desired camera sampling rate and image resolution. Such dynamic adjustments align with distinct embedded OD models stored within the container registry located on the ES. In fact, an embedded engine designed to a specific resolution cannot be seamlessly applied if the latter varies at runtime. This synergy between the Camera Sampling Module and the containerized models underscores Furcifer's ability to match detection demands with resource availability, enabling seamless contextual adaptation and optimized performance in a wide range of different use cases. Furthermore, this module assumes responsibility for image compression prior to transmission to the ES when EC is selected as computing configuration.

### F. Pareidolia: Low-Complexity Similarity-Based Context Adaptation (Control Logic)

Pareidolia (also referred to as control logic), a concept rooted in human perception, reflects the inclination to perceive distinct, often meaningful shapes or images within random or ambiguous visual patterns. It manifests as a natural cognitive process, wherein the brain attempts to link novel ideas with existing concepts. Leveraging already solved tasks, Furcifer leverages “pareidolia” as a context adaptation approach. The control logic can be in communication with state logic. The control logic is configured to generate a current control signal based on the current state of the mobile device. The current control signal makes a current selection of a computing configuration from the plurality of different computing configurations for execution of at least one containerized task execution engine in the set of containerized task execution engines. Each participating MD maintains a record of previously completed tasks. This historical context empowers the node to discern which computing strategy aligns best with the present system state by identifying analogous past scenarios. When a sufficiently similar context is detected, ES intervention may not be required. The control logic is configured to bypass use of an edge server (ES) for generating the control signal when the current state of the mobile device identifies a task previously executed by the mobile device, or a context previously experienced by the mobile device. Conversely, if an analogous context is not found, pertinent task details are shared with the ES to collaboratively determine the optimal model and computing configuration (EC, LC or SC) that best matches the current system state. The Parecidolic Policy Manager (PPM), as defined, facilitates low-complexity trend forecasting. This predictive process is specifically suited for constrained devices, requiring minimal additional burden on their already limited computational capabilities. As a result of the interplay between the increasing number of concurrent clients and the variability of network conditions, PPM forecasts the expected number of FPS that the mobile device will achieve when employing each considered computing configuration. By considering potential failures when signal strength is minimal, or the number of concurrent clients exceeds the edge server's capabilities. The control logic is further configured with logic to generate current control signal and thereby make the current selection (of the computing configuration) based on the forecast. This predictive functionality enables PPM to anticipate the impact of each strategy choice on FPS and tailor the decision accordingly. PPM forecasting capability comes from a set of predictors, one for each computing strategy (or computing configuration), which based on the current metrics collected by Energon are capable of determine the resulting FPS rate the framework will achieve as a consequence of choosing a specific computing configuration. Additional insights into this module and its performance comparison against a more complex “Deep Reinforcement Learning” agent are discussed later in one of the following sections.

In practice, when the target FPS rate is low and both networking conditions and the number of concurrent clients allow for the use of EC, this is always the preferred choice in terms of extending mobile device battery life and maintaining mAP detection quality. When the number of concurrent tasks remains stable, but signal quality degrades, JPEG compression applied as a pre-processing operation by the mobile device reduces bandwidth usage, enabling EC to remain the preferred choice. In cases where signal strength is severely limited and/or the number of clients connected to the same edge server is excessive, SC becomes preferable to EC because it offloads part of the computation from the server, while reducing bandwidth usage. Finally, under extreme conditions where the edge server is unreachable due to wireless channel limitations or excessive computational load, LC must be selected, even though this choice reduces the mobile device's battery life and result in lower detection quality.

By gradually offloading computation from the edge server when adverse conditions, such as poor signal quality or high load on the edge server, arise, PPM periodically selects the best computing strategy or computing configuration. This is achieved by predicting the FPS for each strategy and then maximizing a simple “utility” U metric for each computing strategy referred to as Cₛ.

$$U ( {C}_{s} ) = \{ \frac{0}{\frac{Acc ( Cs )}{E ( Cs )}} \qquad Equation ( 1 )$$

where U(Cₛ)=0, if Cs does not reach the target FPS rate, and

$$U ( {C}_{s} ) = \frac{Acc ( Cs )}{E ( Cs )} if {C}_{s} reach the target FPS rate$$

where Acc(Cₛ) and E(Cₛ) are the mAP accuracy score and the energy consumption of Cₛ, respectively.

$$From above , it derives : U ( EC ) > U ( SC ) > U ( LC ) \qquad Equation ( 2 )$$

The Equation (2) shows that in case of optimal conditions i.e., very good connectivity between mobile devices and the edge server, the edge computing (EC) configuration is the best choice. However, in real world scenarios, the mobile devices move around and the connectivity between the mobile devices and the edge server may not always be very good. In that, case the second computing strategy i.e., the split computing configuration will be a better option as some work will be transferred to mobile devices. In worse connectivity conditions, the third computing strategy, i.e., the local computing configuration can be used. Although this strategy uses more energy at the mobile devices and the accuracy of the results may also be lower than the other two computing strategies. However, using the above proposed utility metric, a best computing configuration can be used for a given scenario.

The problem as formulated becomes straightforward to solve by introducing our version of SC as an intermediary solution to preserve both detection quality and mobile device battery life.

### Experimental Evaluation

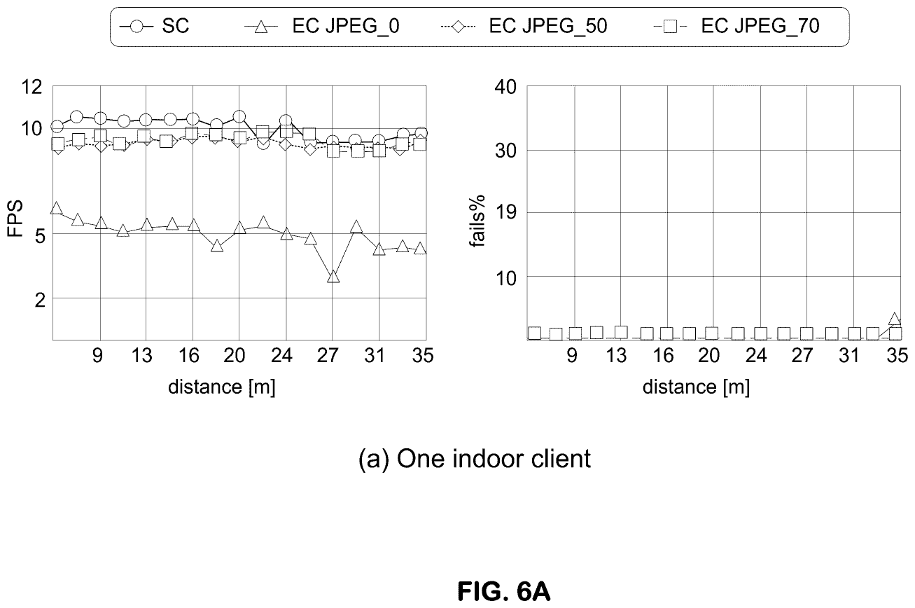

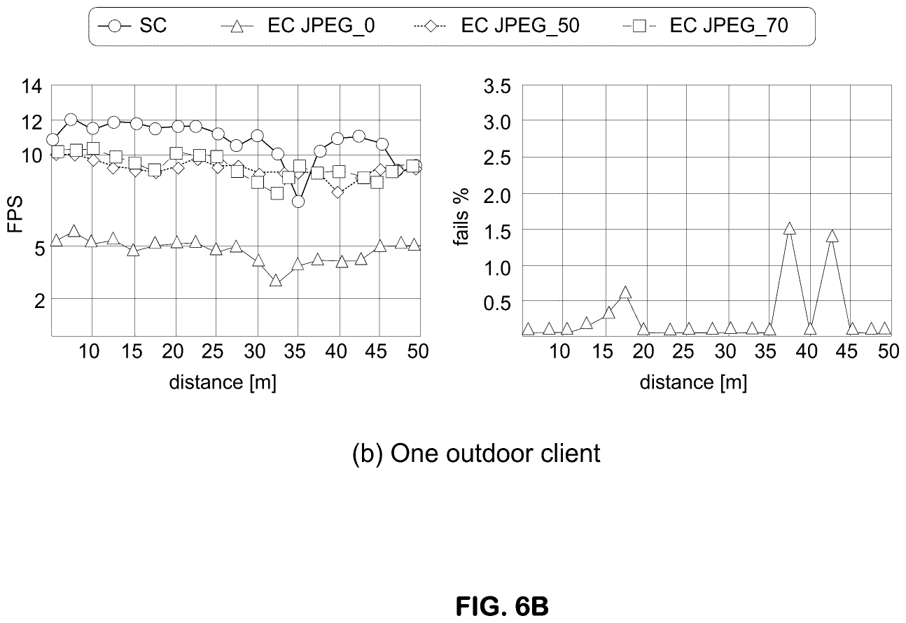

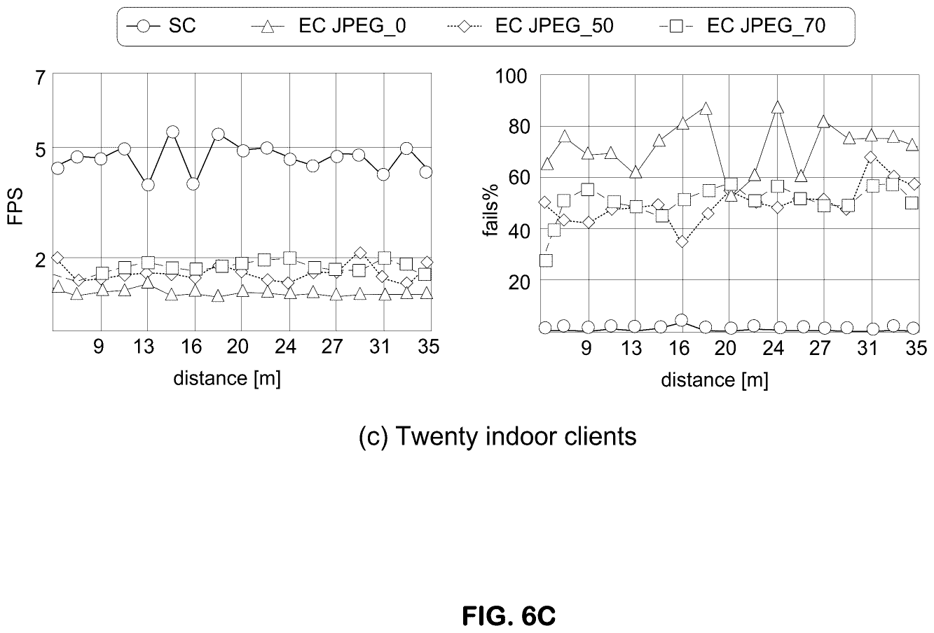

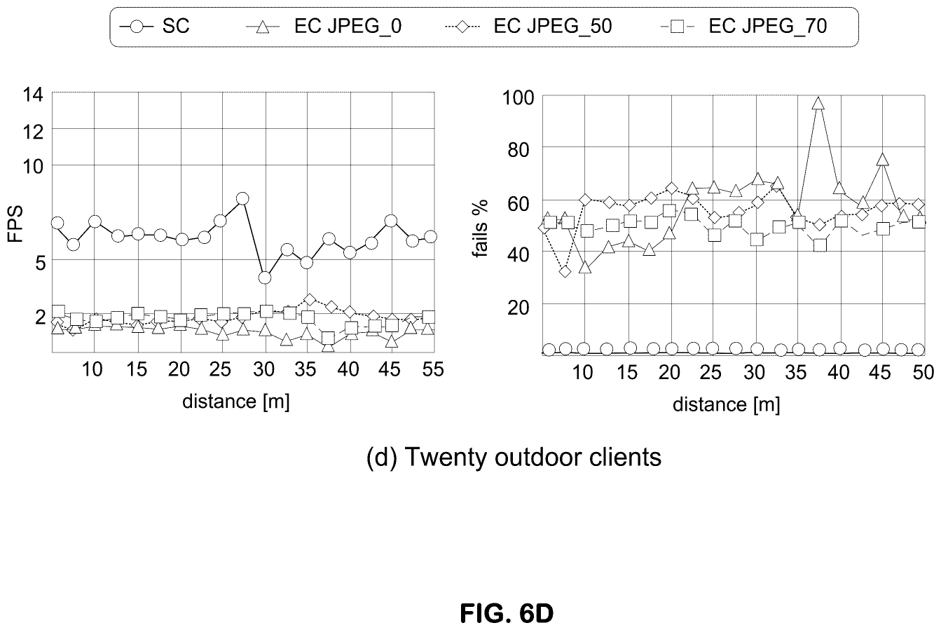

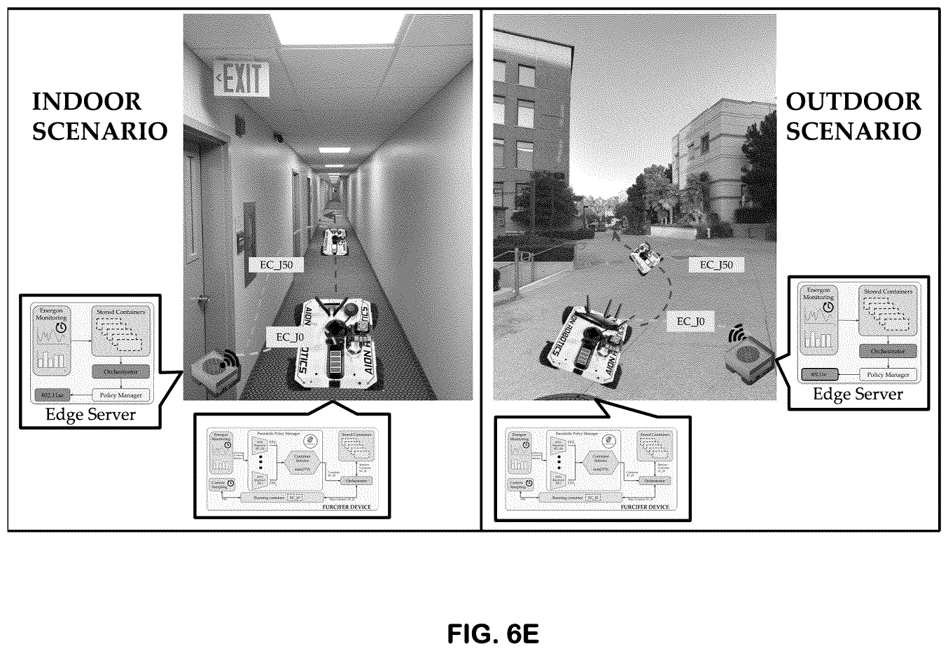

In this section, we present and report the outcome of the experiments conducted using the Furcifer framework. These experiments report relevant performance metrics on a broad range of states and settings of the targeted deployment environment, including outdoor and indoor ones covered with IEEE 802.11n and 802.11ac connectivity. Through this extensive set of experiments, we aim to assess the ability of Furcifer to dynamically adapt the cloud continuum configuration against system state dynamics. We have collected an original dataset consisting of over 250 distinct combinations of channel conditions (expressed as signal strength) and the number of concurrent client connections by moving the mobile device along the corridor of our laboratory and in the open space in front of Donald Bren Hall at the University of California, Irvine (FIG. 6E). While both indoor and outdoor experiments exhibit similar trends, indoor scenarios tend to be characterized by a higher degree of unpredictability, which is primarily due to the presence of obstacles that complicate signal propagation. As a result, the overall channel quality is adversely affected, leading to more variable and less consistent performance outcomes.

### A. IEEE 802.11n Experiments

First, we focus on the widely used Wi-Fi 801.11n standard. Our experimental setup features a Jetson Nano DevKit as the mobile device equipped with a 640 pixels×480 pixels USB Webcam. In indoor scenarios, we orchestrated the movement of the device along a designated path spanning approximately 20 meters. In outdoor scenarios, the path extends over a distance of 50 meters. This deliberate variation allowed us to replicate a spectrum of signal strengths and network dynamics, capturing the intricacies of both indoor environments and outdoor settings. For each experimental run, we meticulously examine the system scalability across different user scenarios. Specifically, we investigate the system performance as the number of clients varies between 1 and 20.

FIGS. 6A and 6B depict the FPS and error percentage metrics for SC and EC with JPEG compression gain 0, 50 and 70% as a function of distance with a single user connected. In the indoor experiment settings (FIG. 6A), there is a striking similarity in the average FPS achieved by EC and SC, with the exception of the scenario involving no image compression.

Conversely, in the outdoor environment (FIG. 6B), SC takes advantage of the improved channel conditions compared to the indoor setting and achieves up to two additional FPS. Importantly, it is worth noting that SC not only excels in FPS but also achieves a higher mAP score compared to LC, showcasing its suitability in terms of both task performance and frame processing speed.

FIGS. 6C and 6D show the performance metrics as the number of clients connected to the ES varies. Several notable trends emerge from this analysis. First, we observe an interesting pattern regarding the impact of image compression techniques as the number of concurrent clients increases. The failure rates associated with JPEG are dramatically larger compared to SC, reaching up to 100% failure rate in some measurements. This result underscores the perils of relying solely on image compression when dealing with a larger number of clients, highlighting the potential limitations of this approach in dynamic and demanding network/server conditions. Conversely, SC achieves almost a steady 0% failure rate due to the small amount of network and server resource used by this configuration. The resulting improved resilience of Furcifer underlines the effectiveness of its context-aware approach, which enables SC to consistently outperform EC in the range of tested network conditions.

### B. IEEE 802.11ac Experiments

Wireless communication channel overhead varies depending on the technology used contributing to the Computing-Wireless Communication trade-off inherited from the SC and EC conditions. We extend the evaluation of Furcifer performance to include IEEE 802.11ac. In these experiments, we replicated the same path for the MD, while concurrently running increasing parallel connections of up to thirty clients. We use a Wi-Fi network interface that supports the IEEE 802.11ac 5 GHz protocol and establish a connection between the ES and MD over an 80 MHz band. Our Wi-Fi 5 Ghz antennas also support MU-MIMO technology which additionally improves the overall communication performance.

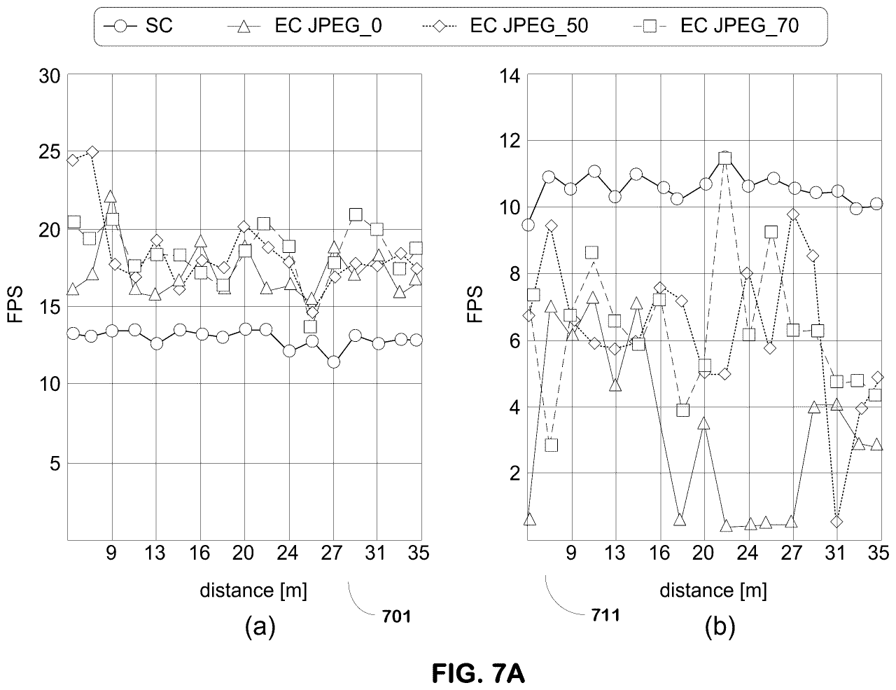

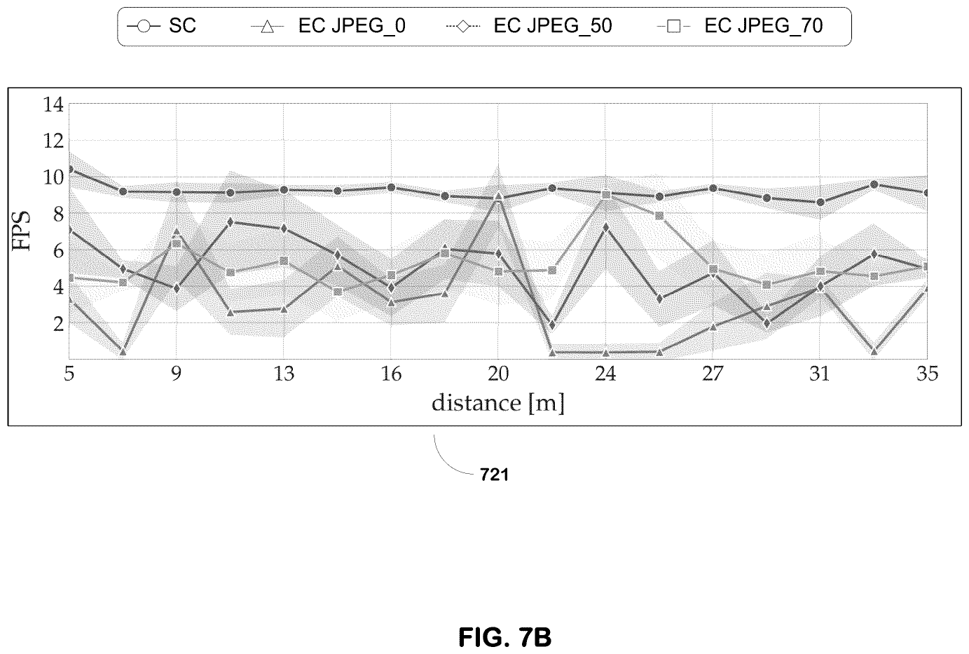

FIGS. 7A and 7B present results for IEEE 802.11ac FPS rate metric for ten, twenty and thirty connected client devices. FIG. 7A presents graphical results for ten and twenty connected client devices while FIG. 7B present graphical results for thirty connected client devices. FIG. 7A shows FPS rate as a function of the number of concurrent clients. A graph 701 shows FPS rates for ten concurrent connected client devices and a graph 711 shows FPS rates for twenty concurrent connected client devices. A graph 721 in FIG. 7B shows FPS rates for thirty concurrent connected client devices. All EC compression strategies benefit from the improved connection capabilities, outperforming SC when the number of clients is smaller than 10. Instead, when the number of clients grows to 20 and 30, the additional load on the ES penalizes EC over SC of about 40% in terms of average FPS successfully processed over the time. As shown in the analysis that follows, the superior performance compared to ES when the system is under pressure is due both to the decrease channel usage and server effort granted by SC. Conversely, when the full capacity of the network and server are available, SC is penalized by the computing effort allocated to the MD.

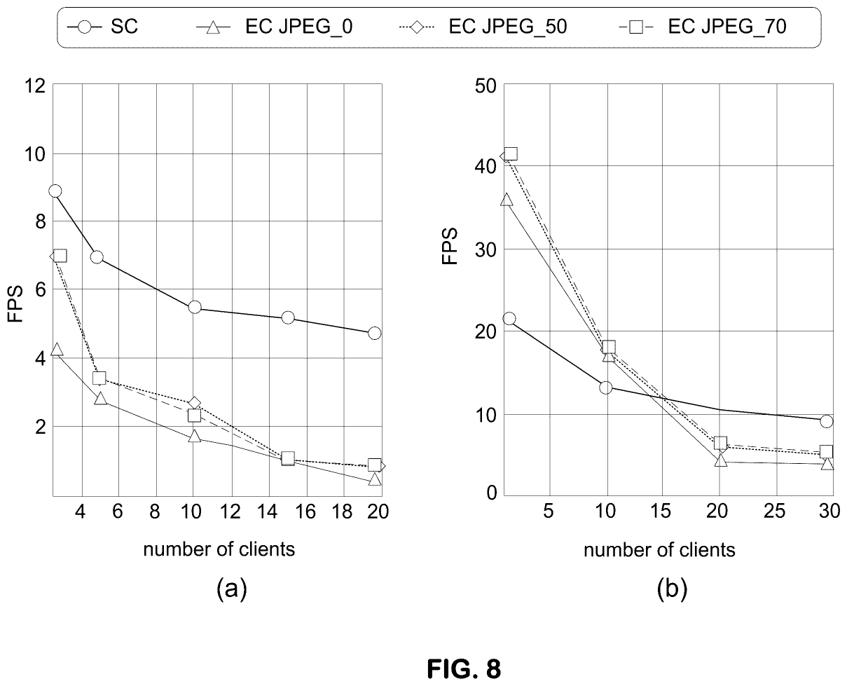

To better appreciate the impact of communications on the computing modality, we conduct a comparative analysis between the IEEE 802.11n and 802.11ac Wi-Fi protocols. The results shown in FIG. 8 depict the achieved FPS as the number of connected clients increases. We note how the improved data rates offered by the IEEE 802.11ac means that EC is the winning solution up to a certain load level, whereas in the IEEE 802.11n experiments the superior compression granted by SC results in the latter being the winning solution. However, this comparison is performed under the same signal strength variability for EC and SC, moving the MD along the same spatial trajectory.

### C. Edge Server Workload Evaluation

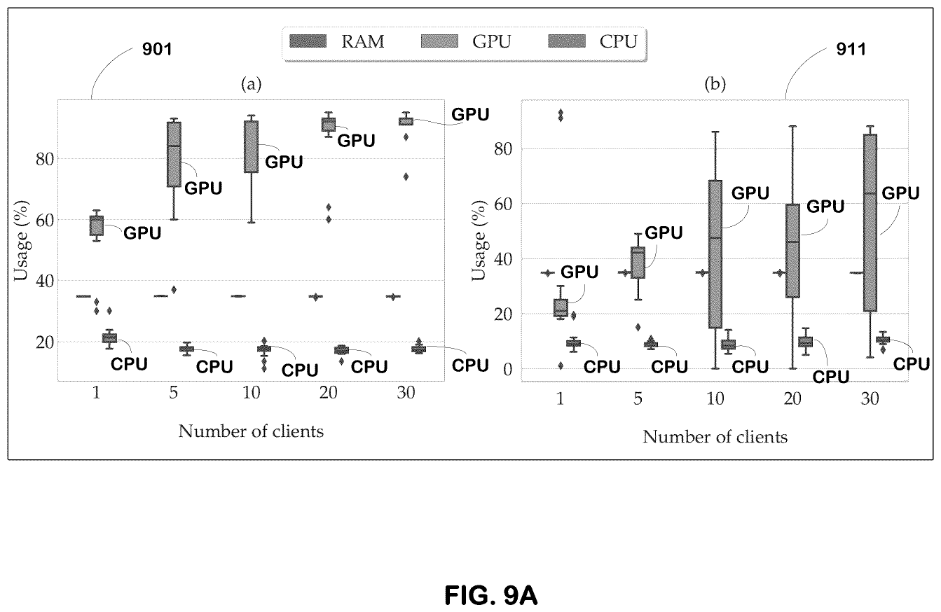

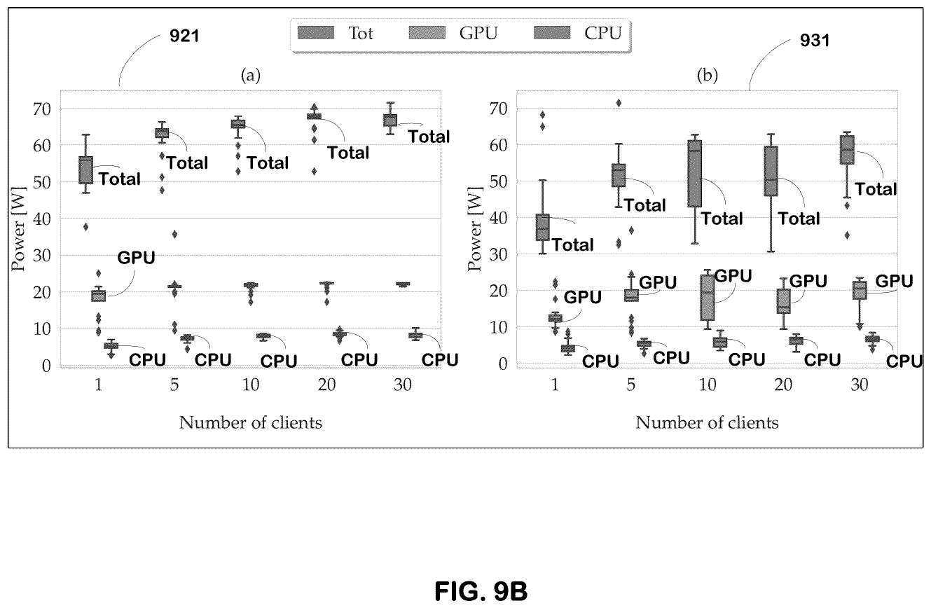

In this section, we focus on the resource usage and the power consumption measured on the ES side as a function of load. ESs are predominantly modeled as devices connected to the power grid, and thus their power consumption can be considered as a performance metric. In this set of experiments, we limited our assessment to EC and SC, as in LC the ES is not involved in the computing pipeline. We select EC JPEG 50 for EC as it obtains higher FPS rate compared with EC without compression and better mAP score compared with EC JPEG 70. FIG. 9A includes two graphs labeled 901 and 911 illustrating comparison between edge computing configuration (graph 901) and split computing configuration (graph 911) in their respective resource utilization on the edge server with an increasing number of client devices. FIG. 9A shows the distribution of computational effort among RAM, CPU and GPU of EC JPEG 50 (901) and Furcifer's SC engine (911). While the percentage of RAM and CPU utilization does not increase as higher number of clients is connected to the ES, EC shows a steady increase in terms of GPU utilization. On the other hand, SC GPU utilization shows a slower degree of growth and a larger variance. Specifically, SC experiences about 25% less GPU utilization on average, accompanied by a three times (or 3×) increase in variance. On average GPU usage is lower in split computing configuration as shown in the graph 911 on the right as compared to GPU usage in edge computing configuration (graph 901 on the left). The average usage of the GPU remains lower (on average) in split computing configuration as compared to edge computing configuration when the number of client devices increases.

FIG. 9B includes two graphs 921 and 931 that illustrate comparison between edge computing configuration and split computing configuration in their respective power consumption on the edge server with an increasing number of client devices. FIG. 9B illustrates the corresponding power consumption of the ES broken down across the same components. As expected, the reduced power consumption of Furcifer's SC in comparison to EC JPEG 50 reflects the lower resource utilization of the former compared to the latter. This results in approximately 20% less power consumption on the edge server side for SC, albeit with two times (or 2×) increase in variance. The total power consumption on average is lower in split computing configuration (graph 931 on the right) as compared to total power consumption on average using edge computing configuration (graph 921 on the left). The total power consumption remains lower (on average) in split computing configuration as compared to edge computing configuration when the number of client devices increases.

### D. Moderately Dynamic Scenario: PPM Reactive Adaptation

In the previous sections, we demonstrated the need for the dynamic adaptation of the computing configuration. We now evaluate the ability of Furcifer—and specifically its policy management module—to provide adaptation capabilities without imposing a significant overhead. In terms of energy consumption and optimal task performance, computing configurations can be clearly ranked based on the MD perspective. In fact, EC does not impose any computing load to the MD and achieves the best mAP thanks to the use of larger models. SC allocates minimal computing effort to the MD and has the second-best mAP. Finally, LC results in the largest energy intake and worst performance. Thus, the decision engine has to evaluate the ability of the individual computing configurations to achieve the desired FPS rate given the currently perceived system state, and then select them in the order dictated by energy and mAP. To support such a decision process, we then build simple KNN regressors that take as input application context metrics such as: the inference time on the ES, the average round trip time, the communication channel quality, and the current resource usage. This produces as output the predicted FPS rate for each considered computing configurations allowing PPM to anticipate the resulting Quality of Service (QOS) of a particular action before executing it.

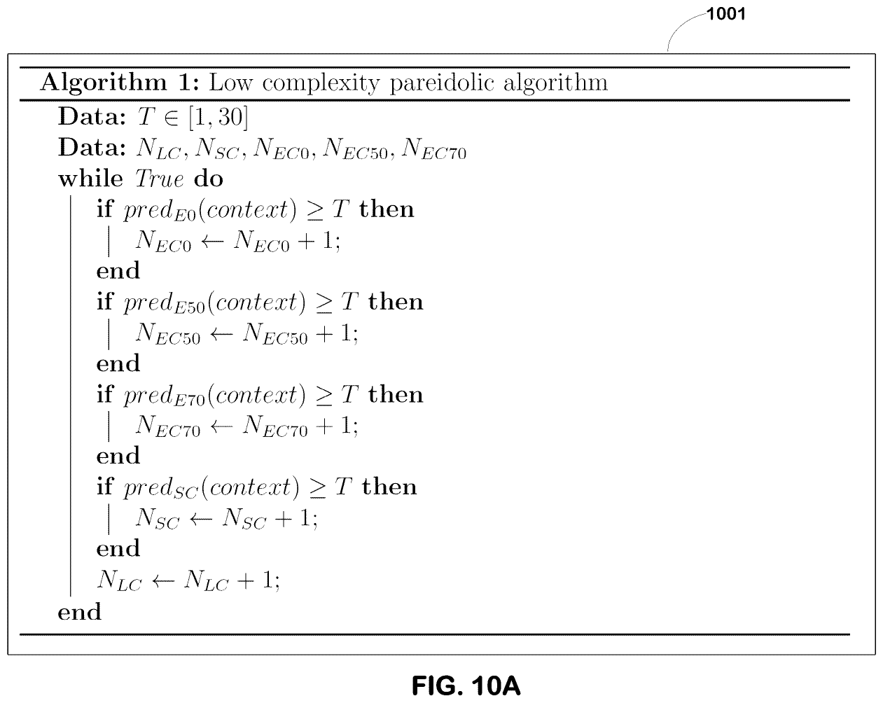

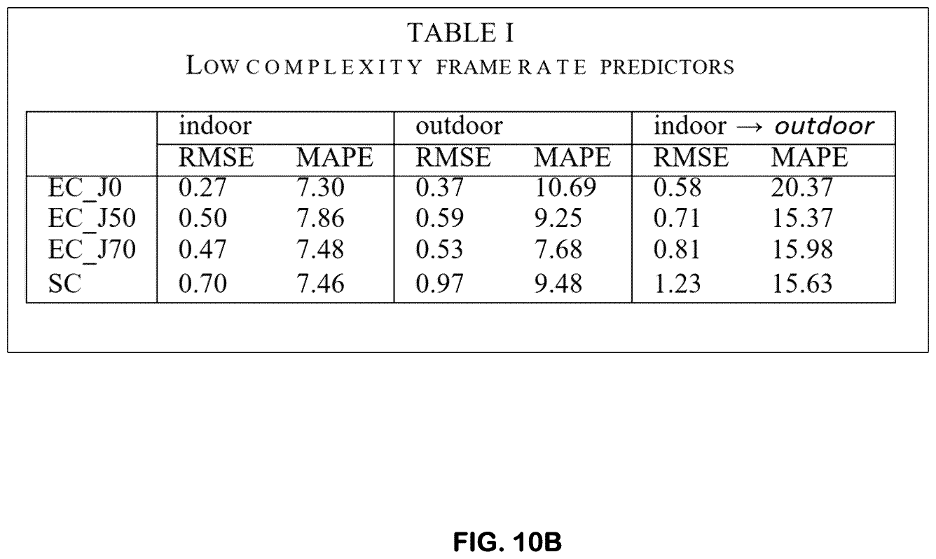

We evaluate the regressors when training and applying them on specific environments (e.g., indoor, or outdoor), as well as on their ability to generalize. The resulting loss metrics are reported in Table I in FIG. 10B. It can be observed that when these regressors are trained on the same context where they are applied, the error is minimal (below 11% MAPE) across all computing configurations. In the case of transfer learning, where models trained indoors are deployed outdoors, the maximum MAPE loss value increases up to 20%. We then structure the decision-making process as a simple set of nested conditions based on simple reactive predictors. FIG. 10A presents an algorithm 1001 (referred to as Algorithm 1 in FIG. 10A) that shows the pseudo code embedded in Furcifer's decision engine.

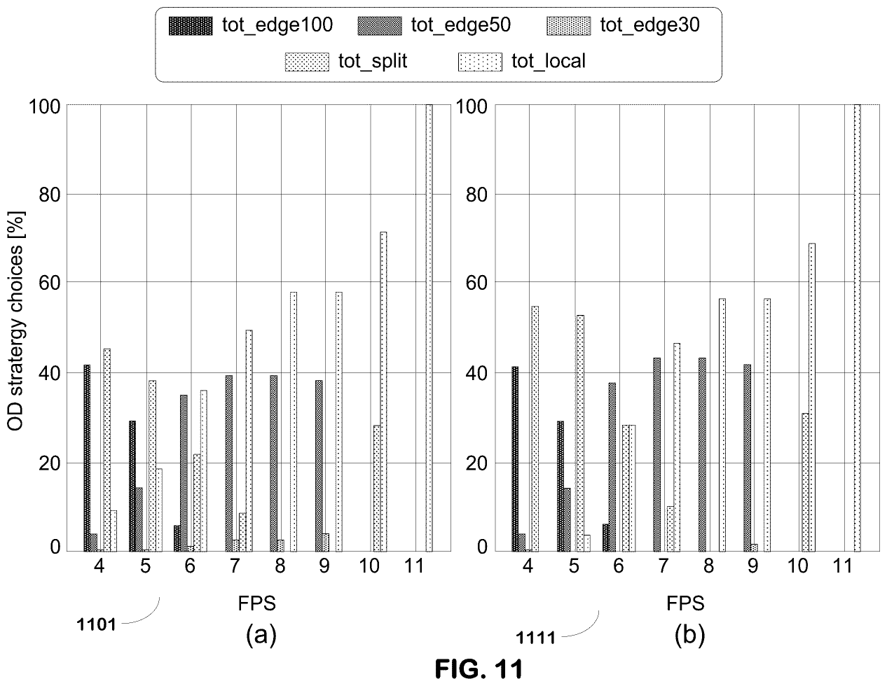

Adaptation Results: We compare Furcifer performance with a static LC solution, which represents the only viable option when the connection quality or system load cannot support the desired FPS rate. FIG. 11 shows the distribution of decisions made by Furcifer policy manager across the spectrum of available cloud continuum strategies. The graphs in FIG. 11 present choices of distribution considered computing configurations depending on target FPS rates for the ground truth oracle (illustrated in graph 1101 on the left) and the Pareidolic Policy manager (illustrated in graph 1111 on the right). It is important to note that our policy manager, despite its low complexity, demonstrates the ability to match the configuration that an oracle controller would implement.

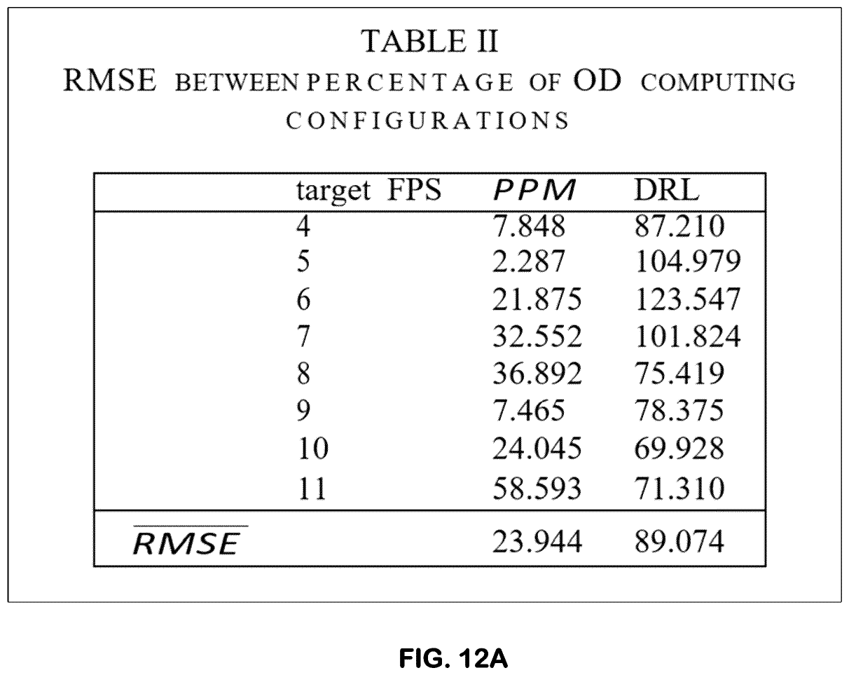

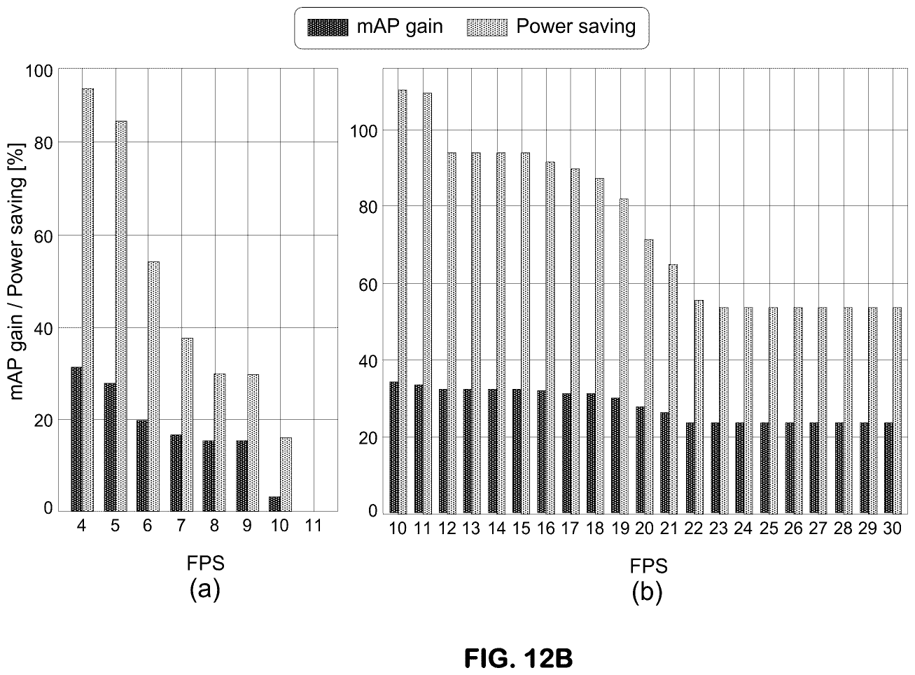

FIG. 12A presents a table (Table II) that reports the Root Mean Squared Error (RMSE) between the percentage of choices made by Furcifer PPM low complexity policy manager and a baseline DRL agent. The striking alignment between the decisions made by Furcifer pareidolic policy manager and the ground truth highlights the feasibility of deploying a low-complexity predictor deployed at the MD, where more complex controllers may fail to train properly or adequately generalize. In the IEEE 802.11n configuration, Furcifer reduces the energy intake by approximately 80% while achieving an average mAP score increase of over 20% in comparison to LC. The relevance of these outcomes is further amplified when using the IEEE 802.11ac protocol. In this scenario, the energy savings exceed 100%, and the mAP consistently maintains a level above 20% for all the defined FPS targets. FIG. 12B shows, Furcifer can easily generalize, accurately predicting the frame per second even when trained on an indoor environment and then tested outdoor.

### E. Highly Dynamic Scenario: PPM Proactive Adaptation

To demonstrate the robustness of PPM against real-world challenges such as unreliable channel connections and sudden fluctuations in the number of concurrent clients, we simulated a scenario with unstable communication channels and high-frequency changes in user numbers. In particular, the MD was moved to a different distance from the ES every 25 seconds. Each new position was chosen to maximize the difference between connection qualities, while also accommodating a sudden increase/decrease in the number of users. Given that switching from one computing strategy to another takes 42±14 ms, reacting instantaneously without trend awareness would result in more than 30% of frames being lost. In real-world scenarios caching cannot be considered a viable solution. For this reason, we extended the capabilities of PPM by adding a smart and low complexity time series forecasting component (also referred to as time series forecasting module). The model architecture consists of 2 layers of LSTM (Long Short Time Memory) with 50 neurons each. The sequence-to-sequence predictive models takes as an input the two most relevant metrics for best class identification which are the channel quality and the number of concurrent connected clients. We explored various sequence lengths to assess the balance between longer forecasting capabilities and the requirement to swiftly adapt to unpredictable context changes. In fact, on one hand a longer forecasting horizon allows for fewer changes in computing strategy, while on the other hand, a shorter window duration provides greater flexibility for the system to adjust to unexpected state changes. Additionally, it's important to note that to ensure the desired frame rate per second (FPS), only the most conservative computing strategy from each predicted sequence can be considered. More accurate offloading strategies such as SC or EC would typically necessitate additional computation and networking resources that may not be readily available during the considered time frame. To validate this, if a computing strategy is chosen for the upcoming interval Δt but cannot be supported by the edge server due to connection issues or resource unavailability (already allocated to other users), the target FPS rate cannot be guaranteed. For our experiment, we set a minimum target of 5 FPS as the QoS requirement to be maintained regardless of external influencing factors. We chose 5 FPS because, as illustrated in FIG. 11, it presents the most critical and heterogeneous distribution for the optimal computing strategy.

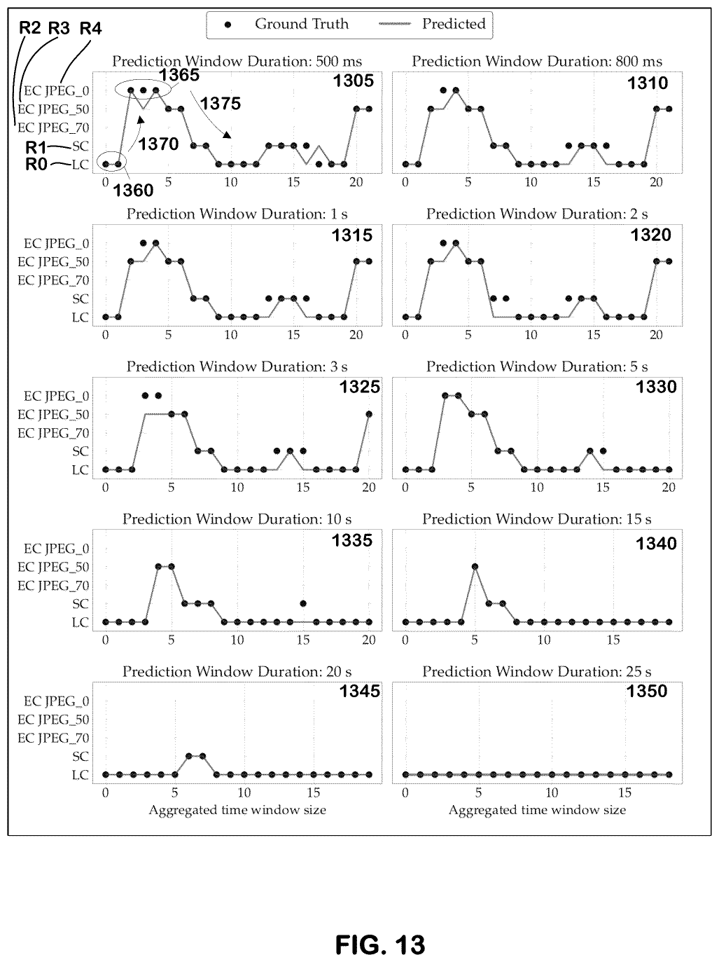

FIG. 13 illustrates the aggregated comparison between the best computing strategies and the predicted ones. Graphs 1305, 1310, 1315, 1320, 1325, 1330, 1335, 1340, 1345 and 1350 in FIG. 13 present comparison between best computing strategy (ground truth) with predicted for each forecasting window size i.e., 500 ms, 800 ms, 1 second, 2 seconds, 3 seconds, 5 seconds, 10 seconds, 15 seconds, 20 seconds, 25 seconds. Each strategy is ranked in descending order of priority: EC₀ (edge computing configuration with zero percent compression of JPEG images) is the most accurate and least energy-consuming for MD, thus it has the highest priority (rank 4 labeled as R4), followed by EC₅0 (rank 3 labeled as R3) and EC₇0 (rank 2 labeled as R2). Finally, SC (rank 1 labeled as R1) and LC (rank 0 labeled R0) complete the ranking where static LC is the only one who does not depend on edge server support and thus is not affected by fluctuating channel quality and concurrent user's connections. EC₅0 and EC₇0 computing configurations have higher image compression such as fifty percent and seventy percent image compression. Clearly, the objective is to offload as much computation as possible to the edge server by utilizing EC or SC, depending on the opportunistic availability of channel and computational resources. As it can be observed, for each considered prediction window. the PPM module takes always the most conservative computing strategy choice even when the prediction does not perfectly match the ground truth. It should be noted that as the prediction window duration increases, the percentage of LC as the most conservative computing strategy also increases. This is due to the increased likelihood of encountering contexts where the channel is either unavailable or saturated with multiple user connections.

The graphs 1305 to 1350 in FIG. 13 present dynamic adaptation of a computing configuration with changing network connectivity. The dark colored circles in each graph represent best computing strategy (or ground truth) and a solid line in each graph represents the computing strategy or computing configuration as predicted by the technology disclosed. As described above, the graphs represent computing configurations for different forecasting windows. The computing configurations change more rapidly for smaller forecasting windows (such as for graph 1305) and the changes in computing configurations become less dynamic as size of forecasting windows increases (such as for graph 1350). Five computing strategies are presented along the vertical axis of each graph. The computing strategies are labeled as R0, R1, R2, R3, and R4. These labels are shown for graph 1305. However, it is understood that the same labels apply to all graphs 1305 to 1350. The horizontal axis of each graph 1305 to 1350 indicates number of forecasting windows. Note that the duration of these forecasting windows increases as the prediction window duration increases from 500 ms for graph 1305 to 25 seconds for graph 1350. Prediction window duration for each graph is presented on the top of the respective graph. Reviewing graph 1305 for 500 ms prediction window duration shows that the best strategy in the beginning is local computing configuration, represented by two circles indicated by a label 1360. This can be due to no connection of the mobile device with the edge server when the process begins. As the connection is established and the quality of the connection of the mobile device with the edge server increase (as indicated by an arrow 1370), the best computing strategy is edge computing with zero image compression (labeled R4). The circles identified by a label 1365 show this strategy. Then the quality of the network connection of the mobile device with the edge server decreases as indicated by an arrow 1375. Therefore, the technology disclosed adjusts the computing strategy accordingly by selecting edge computing with fifty percent compression and then split computing and then finally local computing as the quality of the connection becomes poor. When the prediction window duration increases, the computing strategy selection becomes less dynamic because over larger time durations there may be at least one instance when the quality of the network becomes poor and therefore, the best strategy is always to select local computing configuration (as shown in graph 1350) or in some cases split computing may be selected (as shown in graph 1345).

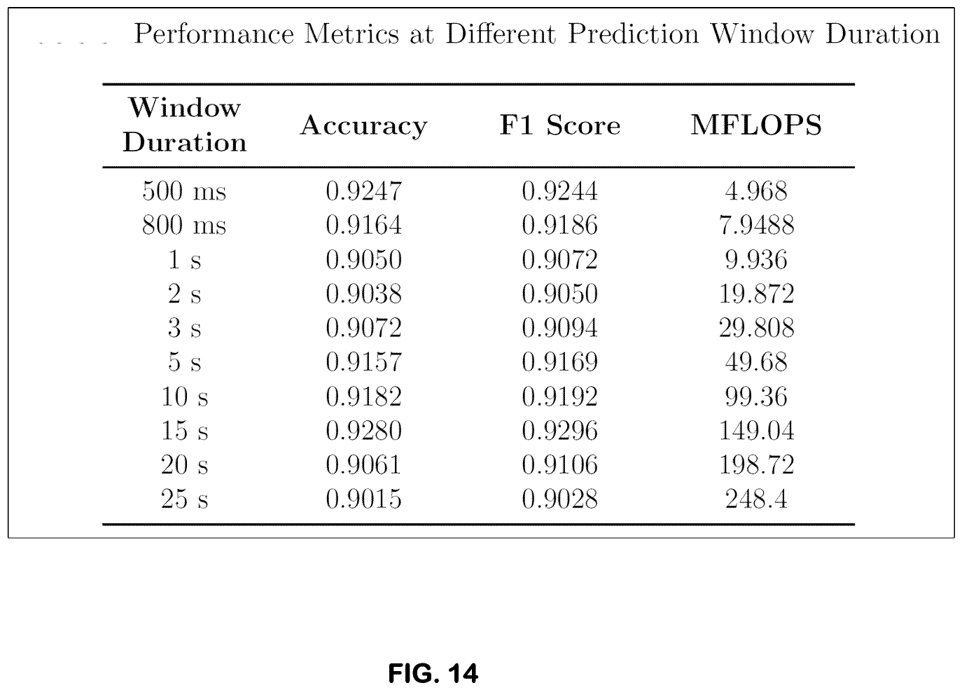

FIG. 14 presents a table that reports the resulting accuracy and FI score for the sequence-to-sequence classification task after 150 epochs. For each predicted window duration, the corresponding amount of MFLOPS (Mega Floating Point Operations per Second) is also reported. As can be observed, even a very small network architecture can easily map the dynamic trend once a conservative approach is adopted.

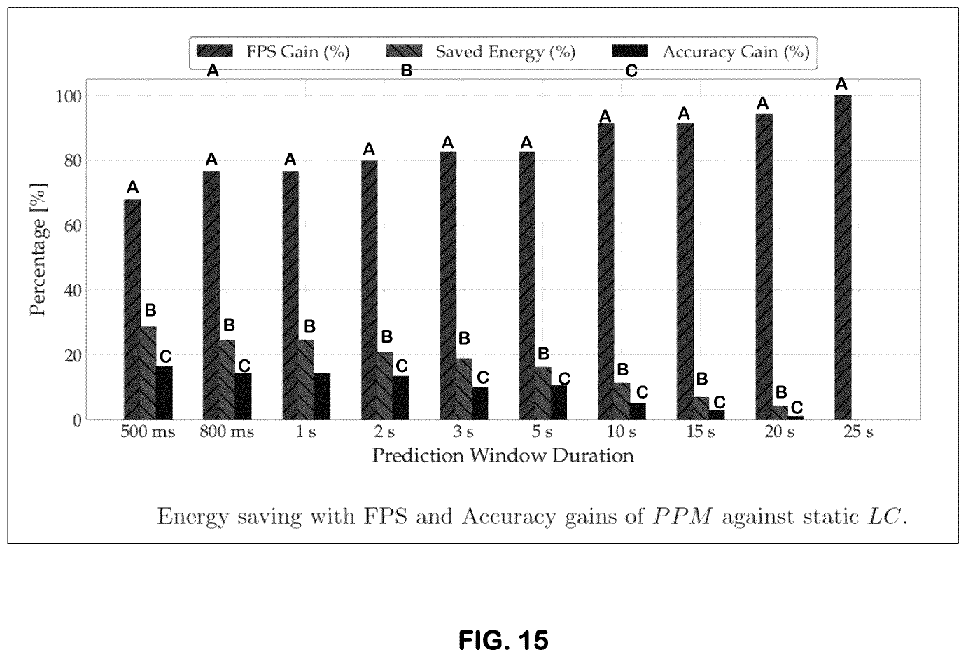

After evaluating the PPM's ability to forecast sub-optimal computing strategies, we assessed the resulting benefits in terms of reduced power consumption, improved accuracy, and minimized loss in FPS (frames per second) rate. FIG. 15 shows the energy saving and the average accuracy gain in terms of mAP score of PPM versus static local computing (LC) configuration as a function of different sequence lengths. Here, the percentage of preserved FPS against instantaneous reacting policy is illustrated, too. As illustrated, a longer prediction window duration results in smaller percentages of energy savings and accuracy gains. Conversely, the percentage of additional processed frames increases due to fewer switches in computational strategies. In FIG. 15, the FPS gain (%) is labeled as “A”, saved energy (%) is labeled as “B” and accuracy gain (%) is labeled as “C” on respective graphical bars for various prediction window durations.

The technology disclosed provides an innovative middleware for the dynamic seamless adjustments of adaptive split computing decisions on the cloud continuum, in particular targeted to real-time object detection in pervasive and mobile execution environments. By leveraging container-based and low-complexity predictors, Furcifer offers an extremely low-overhead solution that proves effective across various deployment environments, system states, and wireless settings. In addition to edge computing (EC) and local computing (LC), we developed a highly optimized Split Computing model that performs supervised compression, establishing it as an effective third adaptive split computing configuration. Our experiments cover diverse scenarios, including both stable and highly dynamic conditions with gradual and unpredictable changes in connection quality and concurrent clients. Under stable conditions, Furcifer demonstrates significant benefits: achieving a two-times (2×) reduction in energy consumption, a 30% higher mean Average Precision (mAP) score compared to local computing, and a three-fold FPS increase over static offloading. In highly dynamic environments with unreliable connectivity and rapid increases in concurrent clients, Furcifer's policy management preserves up to 30% energy, achieving a 16% higher accuracy rate, and completing 80% more frame inferences compared to both local computing and approaches without trend forecasting, respectively. On the edge server side, the overall load is reduced by up to 25% compared to traditional edge computing, while power consumption is approximately 20% lower.

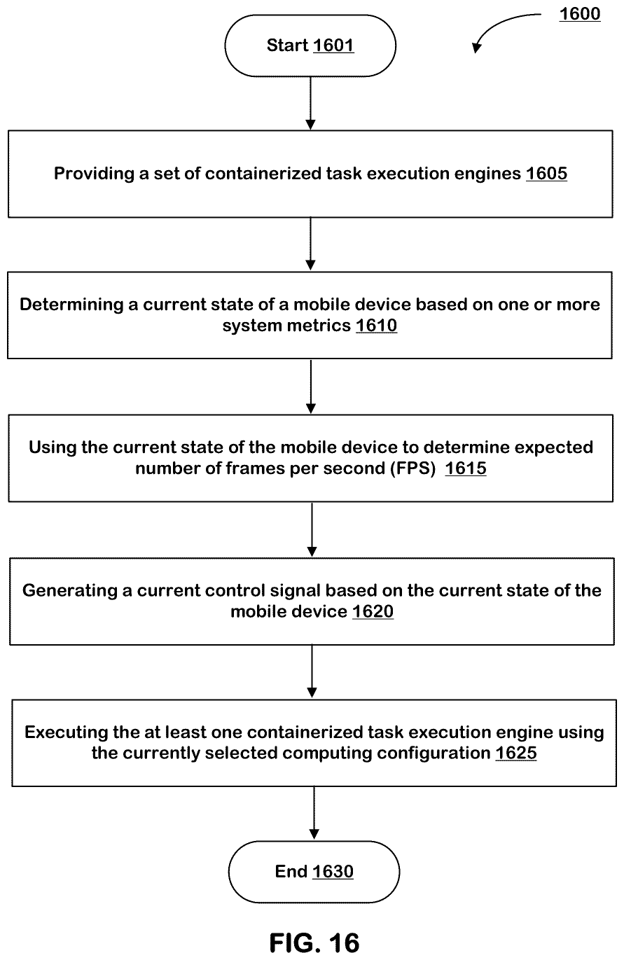

FIG. 16 presents an example process flow diagram illustrating operations performed by the technology disclosed. As with all flow diagrams (or flow charts) herein, it will be appreciated that many of the operations can be combined, performed in parallel or performed in a different sequence without affecting the functions achieved. In some cases, as the reader will appreciate, a re-arrangement of operations will achieve the same results only if certain other changes are made as well. In other cases, as the reader will appreciate, a re-arrangement of operations will achieve the same results only if certain conditions are satisfied. Furthermore, it will be appreciated that the process flow diagram 1600 shows only operations that are pertinent to an understanding of the technology, and it will be understood that numerous additional operations for accomplishing other functions can be performed before, after and between those shown.

The process starts at an operation 1601. The method includes providing a set of containerized task execution engines. A containerized task execution engine is configured to be executed using a computing configuration selected from a plurality of different computing configurations (operation 1605). The method includes determining a current state of the mobile device based on one or more system metrics of the mobile device (operation 1610). The system metrics can be detected from operating system registries of the mobile device. It is understood that the technology disclosed can include other techniques to detect and/or determine system metrics. Examples of system metrics include at least one of energy consumption metrics and resource utilization metrics. The detected system metrics of the mobile device can also include at least one of network quality, packet transmission and drop rates, central processing unit (CPU) usage for individual cores, storage utilization, graphic processing unit (GPU) usage percentage, and temperature measurements. The method includes using the current state of the mobile device to forecast an expected number of frames per second (FPS) that the mobile device will achieve when employing each computing configuration in the plurality of different computing configurations (operation 1615). The method includes generating a current control signal based on the current state of the mobile device (operation 1620). The current control signal makes a current selection of a computing configuration from the plurality of different computing configurations for execution of at least one containerized task execution engine in the set of containerized task execution engines. The method includes executing the at least one containerized task execution engine using the currently selected computing configuration (1625). The process ends at an operation 1630.

### CONCLUSIONS

We present Furcifer, an innovative framework designed to provide seamless adaptation of the cloud continuum computing configuration in dynamic mobile settings. Our approach based on containers and simple predictors result in an extremely low-complexity and low-overhead solution, which we prove effective in a wide set of deployment environments, system states, and wireless settings. In addition to EC and LC, we have developed a highly optimized neural model performing supervised compression, by showing that it represents an extremely effective third computing configuration. In our tests, Furcifer achieves remarkable results, demonstrating a 2× reduction in energy consumption and a 30% additional mAP score gain compared to LC. Additionally, it delivers an impressive three-fold increase in FPS rate when compared to EC. These achievements underscore the considerable impact of Furcifer dynamic adaptation engine in enhancing both energy efficiency and performance.

### Computer System

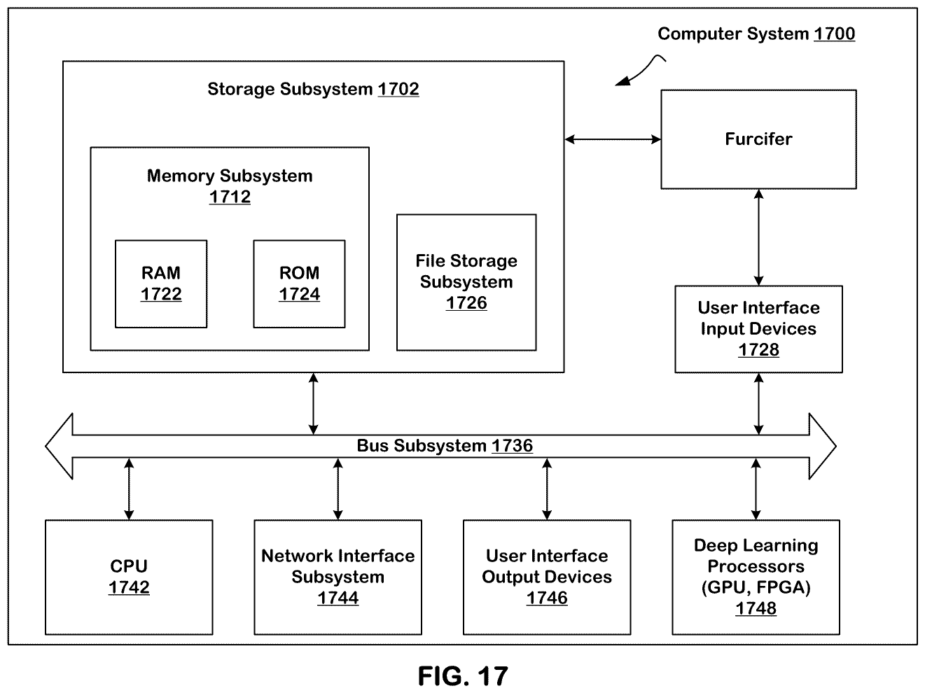

FIG. 17 shows an example computer system 1700 that can be used to implement the technology disclosed. Computer system 1700 includes at least one central processing unit (CPU) 1742 that communicates with a number of peripheral devices via bus subsystem 1726. These peripheral devices can include a storage subsystem 1702 including, for example, memory devices and a file storage subsystem 1726, user interface input devices 1728, user interface output devices 1746, and a network interface subsystem 1744. The input and output devices allow user interaction with computer system 1700. Network interface subsystem 1744 provides an interface to outside networks, including an interface to corresponding interface devices in other computer systems.

In one implementation, Furcifer is communicably linked to the storage subsystem 1702 and the user interface input devices 1728.

User interface input devices 1728 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1700.

User interface output devices 1746 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1700 to the user or to another machine or computer system.

Storage subsystem 1702 stores programming and data constructs that provide the functionality of some or all of the modules and methods described herein. These software modules are generally executed by processors 1748.

Processors 1748 can be graphics processing units (GPUs), field-programmable gate arrays (FPGAs), application-specific integrated circuits (ASICs), and/or coarse-grained reconfigurable architectures (CGRAs). Processors 1748 can be hosted by a deep learning cloud platform such as Google Cloud Platform™, Xilinx™, and Cirrascale™. Examples of processors 1748 include Google's Tensor Processing Unit (TPU)™, rackmount solutions like GX4 Rackmount Series™, GX13 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1712 used in the storage subsystem 1702 can include a number of memories including a main random access memory (RAM) 1722 for storage of instructions and data during program execution and a read only memory (ROM) 1724 in which fixed instructions are stored. A file storage subsystem 1726 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1726 in the storage subsystem 1702, or in other machines accessible by the processor.

Bus subsystem 1736 provides a mechanism for letting the various components and subsystems of computer system 1700 communicate with each other as intended. Although bus subsystem 1736 is shown schematically as a single bus, alternative implementations of the bus subsystem can use multiple busses.

Computer system 1700 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 1700 depicted in FIG. 17 is intended only as a specific example for purposes of illustrating the preferred implementations of the present technology disclosed. Many other configurations of computer system 1700 are possible having more or less components than the computer system depicted in FIG. 17.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 17 is a schematic of an exemplary computing node. Computing node 1700 is only one example of a suitable computing node and is not intended to suggest any limitation as to the scope of use or functionality of embodiments described herein. Regardless, computing node 1700 is capable of being implemented and/or performing any of the functionality set forth hereinabove.

In computing node 1700 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 17, computer system/server in computing node 1700 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Clauses

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

1. A mobile device, comprising:
a set of containerized task execution engines, each containerized task execution engine in the set of containerized task execution engines configured to be executed using a computing configuration selected from a plurality of different computing configurations;
state logic configured to determine a current state of the mobile device based on one or more detected system metrics of the mobile device;
control logic, in communication with the state logic, and configured to generate a current control signal based on the current state of the mobile device, wherein the current control signal makes a current selection of a computing configuration from the plurality of different computing configurations for execution of at least one containerized task execution engine in the set of containerized task execution engines; and runtime logic, in communication with the control logic, and configured to execute the at least one containerized task execution engine using the currently selected computing configuration.

2. The mobile device of clause 1, wherein the plurality of different computing configurations includes edge computing (EC), local computing (LC), and split computing (SC).

3. The mobile device of clause 1, wherein the control logic is further configured to use the current state of the mobile device to forecast an expected number of frames per second (FPS) that the mobile device will achieve when employing each computing configuration in the plurality of different computing configurations.

4. The mobile device of clause 3, wherein the control logic is further configured to generate the current control signal and thereby make the current selection based on the forecast.

5. The mobile device of clause 2, wherein the control logic is further configured to bypass use of an edge server (ES) for generating the control signal when the current state of the mobile device identifies a task previously executed by the mobile device, or a context previously experienced by the mobile device.

6. The mobile device of clause 1, wherein containerized task execution engines in the set of containerized task execution engines are object detection engines.

7. The mobile device of clause 6, further comprising a containerization logic configured to encapsulate the object detection engines into the containerized task execution engines by bundling code and underlying dependencies.

8. The mobile device of clause 1, wherein the detected system metrics of the mobile device are detected from operating system registries of the mobile device.

9. The mobile device of clause 8, wherein the detected system metrics of the mobile device include at least one of energy consumption metrics and resource utilization metrics.

10. The mobile device of clause 8, wherein the detected system metrics of the mobile device include at least one of network quality, packet transmission and drop rates, central processing unit (CPU) usage for individual cores, storage utilization, graphic processing unit (GPU) usage percentage, and temperature measurements.

11. The mobile device of clause 1, further comprising image compression and storage logic configured to store well-tailored images optimized for each compatible mobile device in specialized container registry of each mobile device, wherein the well-tailored images are cached for future use based on a specific task the mobile device is assigned.

12. The mobile device of clause 6, wherein the objection detection engines comprise a specialized encoder-decoder neural network architecture having a one-channel bottleneck in initial layers of a feature extraction segment of the specialized encoder-decoder neural network architecture, and the specialized encoder-decoder neural network incorporating INT8 quantization at an end of the specialized encoder-decoder neural network architecture.

13. A computer-implemented method, including:
providing a set of containerized task execution engines, each containerized task execution engine in the set of containerized task execution engines configured to be executed using a computing configuration selected from a plurality of different computing configurations;
determining a current state of the mobile device based on one or more detected system metrics of the mobile device;
generating a current control signal based on the current state of the mobile device, wherein the current control signal makes a current selection of a computing configuration from the plurality of different computing configurations for execution of at least one containerized task execution engine in the set of containerized task execution engines; and
executing the at least one containerized task execution engine using the currently selected computing configuration.

14. The computer-implemented method of clause 13, wherein the plurality of different computing configurations includes edge computing (EC), local computing (LC), and split computing (SC).

15. The computer-implemented method of clause 13, further including using the current state of the mobile device to forecast an expected number of frames per second (FPS) that the mobile device will achieve when employing each computing configuration in the plurality of different computing configurations.

16. The computer-implemented method of clause 15, further including generating the current control signal and thereby making the current selection based on the forecast.

17. The computer-implemented method of clause 14, further including bypassing use of an edge server (ES) for generating the control signal when the current state of the mobile device identifies a task previously executed by the mobile device, or a context previously experienced by the mobile device.

18. The computer-implemented method of clause 13, wherein containerized task execution engines in the set of containerized task execution engines are object detection engines.

19. The computer-implemented method of clause 18, further including encapsulating the object detection engines into the containerized task execution engines by bundling code and underlying dependencies.

20. The computer-implemented method of clause 13, wherein the detected system metrics of the mobile device are detected from operating system registries of the mobile device.

21. The computer-implemented method of clause 20, wherein the detected system metrics of the mobile device include at least one of energy consumption metrics and resource utilization metrics.

22. The computer-implemented method of clause 20, wherein the detected system metrics of the mobile device include at least one of network quality, packet transmission and drop rates, central processing unit (CPU) usage for individual cores, storage utilization, graphic processing unit (GPU) usage percentage, and temperature measurements.

23. The computer-implemented method of clause 13, further including storing well-tailored images optimized for each compatible mobile device in specialized container registry of each mobile device, wherein the well-tailored images are cached for future use based on a specific task the mobile device is assigned.

24. The computer-implemented method of clause 18, wherein the objection detection engines comprise a specialized encoder-decoder neural network architecture having a one-channel bottleneck in initial layers of a feature extraction segment of the specialized encoder-decoder neural network architecture, and the specialized encoder-decoder neural network incorporating INT8 quantization at an end of the specialized encoder-decoder neural network architecture.

25. A non-transitory computer readable storage medium impressed with computer program instructions, the instructions, when executed on a processor, implement a method comprising:
providing a set of containerized task execution engines, each containerized task execution engine in the set of containerized task execution engines configured to be executed using a computing configuration selected from a plurality of different computing configurations;
determining a current state of the mobile device based on one or more detected system metrics of the mobile device;
generating a current control signal based on the current state of the mobile device, wherein the current control signal makes a current selection of a computing configuration from the plurality of different computing configurations for execution of at least one containerized task execution engine in the set of containerized task execution engines; and
executing the at least one containerized task execution engine using the currently selected computing configuration.

26. The non-transitory computer readable storage medium of clause 25, wherein the plurality of different computing configurations includes edge computing (EC), local computing (LC), and split computing (SC).

27. The non-transitory computer readable storage medium of clause 25, implementing the method further comprising using the current state of the mobile device to forecast an expected number of frames per second (FPS) that the mobile device will achieve when employing each computing configuration in the plurality of different computing configurations.

28. The non-transitory computer readable storage medium of clause 27, implementing the method further comprising generating the current control signal and thereby making the current selection based on the forecast.

29. The non-transitory computer readable storage medium of clause 26, implementing the method further comprising bypassing use of an edge server (ES) for generating the control signal when the current state of the mobile device identifies a task previously executed by the mobile device, or a context previously experienced by the mobile device.

30. The non-transitory computer readable storage medium of clause 25, wherein containerized task execution engines in the set of containerized task execution engines are object detection engines.

31. The non-transitory computer readable storage medium of clause 30, implementing the method further comprising encapsulating the object detection engines into the containerized task execution engines by bundling code and underlying dependencies.

32. The non-transitory computer readable storage medium of clause 25, wherein the detected system metrics of the mobile device are detected from operating system registries of the mobile device.

33. The non-transitory computer readable storage medium of clause 32, wherein the detected system metrics of the mobile device include at least one of energy consumption metrics and resource utilization metrics.

34. The non-transitory computer readable storage medium of clause 32, wherein the detected system metrics of the mobile device include at least one of network quality, packet transmission and drop rates, central processing unit (CPU) usage for individual cores, storage utilization, graphic processing unit (GPU) usage percentage, and temperature measurements.

35. The non-transitory computer readable storage medium of clause 25, implementing the method further comprising storing well-tailored images optimized for each compatible mobile device in specialized container registry of each mobile device, wherein the well-tailored images are cached for future use based on a specific task the mobile device is assigned.

36. The non-transitory computer readable storage medium of clause 30, wherein the objection detection engines comprise a specialized encoder-decoder neural network architecture having a one-channel bottleneck in initial layers of a feature extraction segment of the specialized encoder-decoder neural network architecture, and the specialized encoder-decoder neural network incorporating INT8 quantization at an end of the specialized encoder-decoder neural network architecture.

What is claimed is:

1. A mobile device, comprising:
a set of containerized task execution engines, each containerized task execution engine in the set of containerized task execution engines configured to be executed using a computing configuration selected from a plurality of different computing configurations;
state logic configured to determine a current state of the mobile device based on one or more detected system metrics of the mobile device;
control logic, in communication with the state logic, and configured to generate a current control signal based on the current state of the mobile device, wherein the current control signal makes a current selection of a computing configuration from the plurality of different computing configurations for execution of at least one containerized task execution engine in the set of containerized task execution engines; and
runtime logic, in communication with the control logic, and configured to execute the at least one containerized task execution engine using the currently selected computing configuration.

2. The mobile device of claim 1, wherein the plurality of different computing configurations includes edge computing (EC), local computing (LC), and split computing (SC).

3. The mobile device of claim 1, wherein the control logic is further configured to use the current state of the mobile device to forecast an expected number of frames per second (FPS) that the mobile device will achieve when employing each computing configuration in the plurality of different computing configurations.

4. The mobile device of claim 3, wherein the control logic is further configured to generate the current control signal and thereby make the current selection based on the forecast.

5. The mobile device of claim 2, wherein the control logic is further configured to bypass use of an edge server (ES) for generating the control signal when the current state of the mobile device identifies a task previously executed by the mobile device, or a context previously experienced by the mobile device.

6. The mobile device of claim 1, wherein containerized task execution engines in the set of containerized task execution engines are object detection engines.

7. The mobile device of claim 6, further comprising a containerization logic configured to encapsulate the object detection engines into the containerized task execution engines by bundling code and underlying dependencies.

8. The mobile device of claim 1, wherein the detected system metrics of the mobile device are detected from operating system registries of the mobile device.

9. The mobile device of claim 8, wherein the detected system metrics of the mobile device include at least one of energy consumption metrics and resource utilization metrics.

10. The mobile device of claim 8, wherein the detected system metrics of the mobile device include at least one of network quality, packet transmission and drop rates, central processing unit (CPU) usage for individual cores, storage utilization, graphic processing unit (GPU) usage percentage, and temperature measurements.

11. The mobile device of claim 6, wherein the objection detection engines comprise a specialized encoder-decoder neural network architecture having a one-channel bottleneck in initial layers of a feature extraction segment of the specialized encoder-decoder neural network architecture, and the specialized encoder-decoder neural network incorporating INT8 quantization at an end of the specialized encoder-decoder neural network architecture.

12. A computer-implemented method, including:
providing a set of containerized task execution engines, each containerized task execution engine in the set of containerized task execution engines configured to be executed using a computing configuration selected from a plurality of different computing configurations;
determining a current state of a mobile device based on one or more detected system metrics of the mobile device;
generating a current control signal based on the current state of the mobile device, wherein the current control signal makes a current selection of a computing configuration from the plurality of different computing configurations for execution of at least one containerized task execution engine in the set of containerized task execution engines; and
executing the at least one containerized task execution engine using the currently selected computing configuration.

13. The computer-implemented method of claim 12, wherein the plurality of different computing configurations includes edge computing (EC), local computing (LC), and split computing (SC).

14. The computer-implemented method of claim 12, further including using the current state of the mobile device to forecast an expected number of frames per second (FPS) that the mobile device will achieve when employing each computing configuration in the plurality of different computing configurations.

15. The computer-implemented method of claim 14, further including generating the current control signal and thereby making the current selection based on the forecast.

16. The computer-implemented method of claim 13, further including bypassing use of an edge server (ES) for generating the control signal when the current state of the mobile device identifies a task previously executed by the mobile device, or a context previously experienced by the mobile device.

17. The computer-implemented method of claim 12, wherein containerized task execution engines in the set of containerized task execution engines are object detection engines.

18. The computer-implemented method of claim 17, further including encapsulating the object detection engines into the containerized task execution engines by bundling code and underlying dependencies.

19. The computer-implemented method of claim 17, wherein the objection detection engines comprise a specialized encoder-decoder neural network architecture having a one-channel bottleneck in initial layers of a feature extraction segment of the specialized encoder-decoder neural network architecture, and the specialized encoder-decoder neural network incorporating INT8 quantization at an end of the specialized encoder-decoder neural network architecture.

20. A non-transitory computer readable storage medium impressed with computer program instructions, the instructions, when executed on a processor, implement a method comprising:
providing a set of containerized task execution engines, each containerized task execution engine in the set of containerized task execution engines configured to be executed using a computing configuration selected from a plurality of different computing configurations;
determining a current state of a mobile device based on one or more detected system metrics of the mobile device;
generating a current control signal based on the current state of the mobile device, wherein the current control signal makes a current selection of a computing configuration from the plurality of different computing configurations for execution of at least one containerized task execution engine in the set of containerized task execution engines; and
executing the at least one containerized task execution engine using the currently selected computing configuration.
